(19) United States
(12) Patent Application Publication
(10) Pub. No.: US 2026/0261909 A1
(43) Pub. Date: Sep. 3, 2026

(54) INFORMATION MATRIX COMPRESSION

(71) Applicant: Lenovo (United States) Inc., Morrisville, NC (US)

(72) Inventor: Venkata Srinivas Kothapalli, Aurora, IL (US)

(73) Assignee: Lenovo (United States) Inc., Morrisville, NC (US)

(21) Appl. No.: 19/068,878

(22) Filed: Mar. 3, 2025

(51) Int. Cl. H04W 28/06; G06F 17/16; H04B 7/06

(52) U.S. Cl. CPC H04W 28/06; G06F 17/16; H04B 7/0626

(57) ABSTRACT

Various aspects of the present disclosure relate to information matrix compression. An apparatus (e.g., a user equipment (UE) or a network equipment (NE)) decomposes, based at least in part on Hadamard product decomposition, an information matrix into a first factor matrix and a second factor matrix. A product of a rank of the first factor matrix and a rank of the second factor matrix is equal to a rank of the information matrix, and wherein the information matrix includes a set of information parameters. The apparatus encodes the first factor matrix and the second factor matrix to obtain encoded information and transmits the encoded information.

### TECHNICAL FIELD

The present disclosure relates to wireless communications, and more specifically to information matrix compression.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

An apparatus (e.g., a UE or NE) for wireless communication is described. The apparatus may be configured to, capable of, or operable to perform one or more operations as described herein. For example, the apparatus may be configured to, capable of, or operable to decompose, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encode the first factor matrix and the second factor matrix to obtain encoded information; and transmit the encoded information.

A processor (e.g., a standalone processor chipset, or a component of a UE or of an NE) for wireless communication is described. The processor may be configured to, capable of, or operable to perform one or more operations as described herein. For example, the processor may be configured to, capable of, or operable to decompose, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encode the first factor matrix and the second factor matrix to obtain encoded information; and transmit the encoded information.

A method performed or performable by an apparatus (e.g., a UE or an NE) for wireless communication is described. The method may include decomposing, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encoding the first factor matrix and the second factor matrix to obtain encoded information; and transmitting the encoded information.

In some implementations of the apparatus, the processor, and the method described herein, the information matrix comprises a real-valued information matrix. In some implementations of the apparatus, the processor, and the method described herein, the set of information parameters characterize channel state information (CSI).

In some implementations of the apparatus, processor, and method described herein, the apparatus, processor, and method may further be configured to, capable of, performed, performable, or operable to receive one or more reference signals from a device; and determine the CSI based at least in part on the one or more reference signals. In some implementations of the apparatus, the processor, and the method described herein, the CSI comprises a characterization of a channel matrix or a channel covariance matrix.

In some implementations of the apparatus, processor, and method described herein, the apparatus, processor, and method may further be configured to, capable of, performed, performable, or operable to map the set of information parameters to a real-valued information matrix of size r×t, where r≥1, where t≥1, where r is a number of rows in the real-valued information matrix, where t is a number of columns in the real-valued information matrix, and where the set of information parameters are mapped one-to-one to the real-valued information matrix. In some implementations of the apparatus, processor, and method described herein, to encode the first factor matrix and the second factor matrix, the apparatus, processor, and method may further be configured to, capable of, performed, performable, or operable to determine at least one index corresponding to one or more codebooks.

In some implementations of the apparatus, processor, and method described herein, to encode the first factor matrix and the second factor matrix, the apparatus, processor, and method may further be configured to, capable of, performed, performable, or operable to obtain latent representations of the first factor matrix and the second factor matrix, or compute feature vectors of the first factor matrix and the second factor matrix. In some implementations of the apparatus, processor, and method described herein, to encode the first factor matrix and the second factor matrix, the apparatus, processor, and method may further be configured to, capable of, performed, performable, or operable to encode at least one of the first factor matrix and the second factor matrix based at least in part on an identity operation.

In some implementations of the apparatus, processor, and method described herein, the apparatus, processor, and method may further be configured to, capable of, performed, performable, or operable to determine the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix. In some implementations of the apparatus, processor, and method described herein, the apparatus, processor, and method may further be configured to, capable of, performed, performable, or operable to transmit the rank of the first factor matrix and the rank of the second factor matrix.

In some implementations of the apparatus, processor, and method described herein, the apparatus, processor, and method may further be configured to, capable of, performed, performable, or operable to: receive a message signal from a device to which the encoded information was transmitted, where to determine the rank of the first factor matrix and the rank of the second factor matrix, the apparatus, processor, and method may further be configured to, capable of, performed, performable, or operable to determine the rank of the first factor matrix and the rank of the second factor matrix based at least in part on the message signal. In some implementations of the apparatus, processor, and method described herein, the apparatus, processor, and method may further be configured to, capable of, performed, performable, or operable to: receive a message signal from a first device that is different than a second device to which the encoded information was transmitted, where to determine the rank of the first factor matrix and the rank of the second factor matrix, the apparatus, processor, and method may further be configured to, capable of, performed, performable, or operable to determine the rank of the first factor matrix and the rank of the second factor matrix based at least in part on the message signal.

In some implementations of the apparatus, processor, and method described herein, the apparatus, processor, and method may further be configured to, capable of, performed, performable, or operable to transmit, to the first device, an indication of the rank of the first factor matrix and the rank of the second factor matrix. In some implementations of the apparatus, processor, and method described herein, the rank of the first factor matrix is less than the rank of the information matrix and the rank of the second factor matrix is less than the rank of the information matrix.

In some implementations of the apparatus, processor, and method described herein, a dimension of the first factor matrix is equal to a dimension of the information matrix and where a dimension of the second factor matrix is equal to the dimension of the information matrix. In some implementations of the apparatus, processor, and method described herein, to decompose, based at least in part on Hadamard product decomposition, the information matrix into the first factor matrix and the second factor matrix, the apparatus, processor, and method may further be configured to, capable of, performed, performable, or operable to: solve an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix.

In some implementations of the apparatus, processor, and method described herein, the measure of the difference between the information matrix and the Hadamard product of the first factor matrix and the second factor matrix is a matrix norm of a difference matrix obtained from the difference between the information matrix and the Hadamard product of the first factor matrix and the second factor matrix. In some implementations of the apparatus, processor, and method described herein, to decompose the first factor matrix and the second factor matrix, the apparatus, processor, and method may further be configured to, capable of, performed, performable, or operable to decompose, based at least in part on Hadamard product decomposition, the information matrix into the first factor matrix and the second factor matrix based at least in part on an artificial intelligence/machine learning (AI/ML) model.

In some implementations of the apparatus, processor, and method described herein, the apparatus, processor, and method may further be configured to, capable of, performed, performable, or operable to: determine a mapping, where to map the set of information parameters to the real-valued information matrix, the apparatus, processor, and method may further be configured to, capable of, performed, performable, or operable to map the set of information parameters to the real-valued information matrix based at least in part on the mapping. In some implementations of the apparatus, processor, and method described herein, the apparatus, processor, and method may further be configured to, capable of, performed, performable, or operable to: receive, from a device, a mapping, where to map the set of information parameters to the real-valued information matrix, the apparatus, processor, and method may further be configured to, capable of, performed, performable, or operable to map the set of information parameters to the real-valued information matrix based at least in part on the mapping.

In some implementations of the apparatus, processor, and method described herein, the apparatus, processor, and method may further be configured to, capable of, performed, performable, or operable to: transmit, to a device, a mapping, where to map the set of information parameters to the real-valued information matrix, the apparatus, processor, and method may further be configured to, capable of, performed, performable, or operable to map the set of information parameters to the real-valued information matrix based at least in part on the mapping. In some implementations of the apparatus, processor, and method described herein, the apparatus, processor, and method may further be configured to, capable of, performed, performable, or operable to decompose, based at least in part on Hadamard product decomposition, the first factor matrix into a third factor matrix and a fourth factor matrix, and where to encode the first factor matrix, the apparatus, processor, and method may further be configured to, capable of, performed, performable, or operable to encode the third factor matrix and the fourth factor matrix.

In some implementations of the apparatus, processor, and method described herein, the apparatus comprises a UE. In some implementations of the apparatus, processor, and method described herein, the apparatus comprises a NE.

An apparatus (e.g., a UE or NE) for wireless communication is described. The apparatus may be configured to, capable of, or operable to perform one or more operations as described herein. For example, the apparatus may be configured to, capable of, or operable to receive encoded information; decode the encoded information to obtain a first factor matrix and a second factor matrix from a Hadamard product decomposition; and reconstruct an information matrix from the first factor matrix and the second factor matrix, where a product of a rank of the first factor matrix and a rank of the second factor matrix is equal to a rank of the information matrix, and where the information matrix includes a set of information parameters.

A processor (e.g., a standalone processor chipset, or a component of a UE or of an NE) for wireless communication is described. The processor may be configured to, capable of, or operable to perform one or more operations as described herein. For example, the processor may be configured to, capable of, or operable receive encoded information; decode the encoded information to obtain a first factor matrix and a second factor matrix from a Hadamard product decomposition; and reconstruct an information matrix from the first factor matrix and the second factor matrix, where a product of a rank of the first factor matrix and a rank of the second factor matrix is equal to a rank of the information matrix, and where the information matrix includes a set of information parameters.

A method performed or performable by an apparatus (e.g., a UE or an NE) for wireless communication is described. The method may include receiving encoded information; decoding the encoded information to obtain a first factor matrix and a second factor matrix from a Hadamard product decomposition; and reconstructing an information matrix from the first factor matrix and the second factor matrix, where a product of a rank of the first factor matrix and a rank of the second factor matrix is equal to a rank of the information matrix, and where the information matrix includes a set of information parameters.

In some implementations of the apparatus, processor, and method described herein, the information matrix comprises a real-valued information matrix. In some implementations of the apparatus, processor, and method described herein, the set of information parameters characterize CSI.

In some implementations of the apparatus, processor, and method described herein, the apparatus, processor, and method may further be configured to, capable of, performed, performable, or operable to cause the apparatus to transmit one or more reference signals to a device. In some implementations of the apparatus, processor, and method described herein, the CSI comprises a characterization of a channel matrix or a channel covariance matrix.

In some implementations of the apparatus, processor, and method described herein, to reconstruct the information matrix, the apparatus, processor, and method may further be configured to, capable of, performed, performable, or operable to cause the apparatus to determine a Hadamard product of the first factor matrix and the second factor matrix. In some implementations of the apparatus, processor, and method described herein, the information matrix comprises a real-valued information matrix of size r×t, where r=2nᵣ and t=2nₜ, where r is a number of rows in the real-valued information matrix, where t is a number of columns in the real-valued information matrix, where nᵣ is a number of antennas at a device from which the encoded information is received, and where nₜ is a number of antennas at the apparatus.

In some implementations of the apparatus, processor, and method described herein, the apparatus, processor, and method may further be configured to, capable of, performed, performable, or operable to determine a mapping; and map, based at least in part on the mapping, parameters of the real-valued information matrix to a complex-valued matrix. In some implementations of the apparatus, processor, and method described herein, to decode the encoded information, the apparatus, processor, and method may further be configured to, capable of, performed, performable, or operable to identify at least one index corresponding to one or more codebooks.

In some implementations of the apparatus, processor, and method described herein, to decode the first factor matrix and the second factor matrix, the apparatus, processor, and method may further be configured to, capable of, performed, performable, or operable to obtain the first factor matrix and the second factor matrix from latent representations of the first factor matrix and the second factor matrix, or obtain the first factor matrix and the second factor matrix from feature vectors of the first factor matrix and the second factor matrix. In some implementations of the apparatus, processor, and method described herein, to decode the first factor matrix and the second factor matrix, the apparatus, processor, and method may further be configured to, capable of, performed, performable, or operable to decode at least one of the first factor matrix and the second factor matrix based at least in part on an identity operation.

In some implementations of the apparatus, processor, and method described herein, to receive the encoded information, the apparatus, processor, and method may further be configured to, capable of, performed, performable, or operable to receive the encoded information from a device, and where the at least one processor is further operable to cause the apparatus to receive, from the device, the rank of the first factor matrix and the rank of the second factor matrix. In some implementations of the apparatus, processor, and method described herein, the apparatus, processor, and method may further be configured to, capable of, performed, performable, or operable to: transmit, to a device, a message signal based at least in part on which the rank of the first factor matrix and the rank of the second factor matrix can be determined.

In some implementations of the apparatus, processor, and method described herein, the rank of the first factor matrix is less than the rank of the information matrix and the rank of the second factor matrix is less than the rank of the information matrix. In some implementations of the apparatus, processor, and method described herein, a dimension of the first factor matrix is equal to a dimension of the information matrix and a dimension of the second factor matrix is equal to the dimension of the information matrix.

In some implementations of the apparatus, processor, and method described herein, to receive the encoded information, the apparatus, processor, and method may further be configured to, capable of, performed, performable, or operable to receive the encoded information from a device, and where the at least one processor is further operable to cause the apparatus to receive the mapping from the device. In some implementations of the apparatus, processor, and method described herein, to receive the encoded information, the apparatus, processor, and method may further be configured to, capable of, performed, performable, or operable to receive the encoded information from a first device, and where the at least one processor is further operable to cause the apparatus to receive the mapping from a second device that is different than the first device.

In some implementations of the apparatus, processor, and method described herein, to decode the first factor matrix, the apparatus, processor, and method may further be configured to, capable of, performed, performable, or operable to decode a third factor matrix and a fourth factor matrix, and the at least one processor is further operable to cause the apparatus to reconstruct the first factor matrix from the third factor matrix and the fourth factor matrix. In some implementations of the apparatus, processor, and method described herein, to receive the encoded information, the apparatus, processor, and method may further be configured to, capable of, performed, performable, or operable to receive the encoded information from a UE.

### BRIEF DESCRIPTION OF THE DRAWINGS

FIG. 1 illustrates an example of a wireless communications system in accordance with aspects of the present disclosure.

FIG. 2 illustrates an example of receiving and transmitting nodes in accordance with aspects of the present disclosure.

FIG. 3 illustrates an aperiodic trigger state defining a list of CSI report settings.

FIG. 4 illustrates an information element pertaining to CSI reporting.

FIG. 5 illustrates an information element for radio resource control (RRC) configuration for wireless resources.

FIG. 6 illustrates a scenario for partial CSI omission for physical uplink shared channel (PUSCH) based CSI.

FIG. 7 illustrates an example signaling diagram in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of an NE in accordance with aspects of the present disclosure.

FIG. 11 illustrates a flowchart of a method in accordance with aspects of the present disclosure.

FIG. 12 illustrates a flowchart of a method in accordance with aspects of the present disclosure.

### DETAILED DESCRIPTION

A wireless network can include multiple nodes that can include one or more UEs and one or more NEs. The wireless network can include multiple antennas at a transmitting node and multiple antennas at a receiving node, such as a UE having nᵣ antennas and an NE (e.g., base station) having nₜ antennas. In such examples, a wireless channel between the NE and the UE has a total of nᵣ×nₜ number of paths, where each path refers to a portion (e.g., a sub-channel) of the wireless channel in which wireless communication occurs between one of the nᵣ antennas and one of the nₜ antennas. In the downlink (DL) communication, where the NE sends information to the UE, a discrete-time channel can be represented as a nᵣ×nₜ dimensional complex-valued matrix H (e.g., wireless channel matrix), with element hᵢⱼ of H denoting the complex-valued channel gain between i^{th} receive antenna and j^{th} transmit antenna, where 1≤i≤r, and 1≤j≤t.

The wireless channel gains, or the wireless channel matrix H, depends on a physical propagation medium, and due to the dynamic nature of the physical propagation medium, the wireless channel is a time-varying channel. Further, the channel gains depend on the frequency of operation—with a multicarrier waveform, such as orthogonal frequency division multiplexing (OFDM), the channel matrix can assume different values at different sub-carriers (e.g., frequencies) at the same instant of time. In other words, the wireless channel matrix H is stochastic in nature, varying across time, frequency and spatial dimensions. By adapting the transmission method as per the channel realization or pre-processing the information signal to be transmitted according to the current channel realization, better throughput can be achieved over the communication link while making the link more reliable.

To achieve such an adaptive transmission or to implement pre-processing at the transmitter, CSI is communicated (e.g., transmitted, sent, signaled) to the transmitter. This amounts to the transmitter knowing the wireless channel matrix H over the entire frequency range of operation (e.g., at every sub-carrier in the case of OFDM/multi-carrier waveforms) every time the channel changes.

The receiver estimates the channel through reference or pilot signals communicated (e.g., transmitted, sent, signaled) by the transmitter and communicates (e.g., transmits, sends, signals) the acquired channel knowledge to the transmitter by communicating (e.g., transmitting, sending, signaling) back, or feeding back, the CSI the receiver acquired. Thus, in a DL communication (e.g., from a NE to a UE), the UE estimates the DL CSI (typically, the channel matrix, or the channel covariance matrix) with the help of pilot or reference signals communicated by the NE, and communicates (e.g., transmits, sends, signals) the estimated CSI back to the NE. Similarly, in the uplink (UL) communication from a UE to the NE, the NE estimates the CSI based on UL reference or pilot signals communicated (e.g., transmitted, sent, signaled) from the UE, and communicates (e.g., transmits, sends, signals) the estimated CSI back to the UE.

Feedback of the estimated CSI is an overhead for the wireless network as it is not user data. Accordingly, one challenge faced in the wireless network is to reduce the CSI overhead sent in the form of feedback from the receiver (e.g., the UE) while allowing the transmitter (e.g., the NE) to acquire CSI of sufficient quality to enable it to improve the communication over the link. The signaling overhead used for CSI feedback increases with the rank of the underlying multiple input multiple output (MIMO) channels. When considering the signaling used for the feedback of CSI of MIMO channels, it is readily understood that the signaling increases linearly with the rank of the CSI matrix. The rank of a matrix, such as the CSI matrix, refers to the dimension of the vector space that is generated or spanned by the columns or rows of the matrix. For example, the rank of a matrix is a largest number of linearly independent columns or rows in the matrix.

This disclosure describes a lossy compression technique for compressing the wireless channel matrix H that reduces the amount of CSI information feedback from the receiver (e.g., the UE). The lossy compression techniques are particularly useful for compressing MIMO channel matrices having higher ranks.

Generally, at a receiver an information matrix, such as a MIMO channel matrix that includes CSI information, is decomposed based at least in part on Hadamard product decomposition. The Hadamard product decomposition results in at least two factor matrices, where a product of the ranks of the at least two factor matrices is equal to the rank of the information matrix. The at least two factor matrices are encoded, and the encoded factor matrices are communicated (e.g., transmitted, sent, signaled) to the transmitter. The transmitter can then decode the encoded at least two factor matrices and reconstruct the information matrix from the at least two factor matrices.

In one or more implementations, the sum of the ranks of the at least two factor matrices is less than the rank of the information matrix, reducing the amount of data that is fed back to the transmitter. For example, an information matrix having a rank of 9 can be encoded and communicated (e.g., transmitted, sent, signaled) to the transmitter using 9 vectors. However, if that information matrix is decomposed into two factor matrices each having a rank of 3, each of the two factor matrices can be encoded and communicated (e.g., transmitted, sent, signaled) to the transmitter using 3 vectors. Accordingly, in this example, the CSI information is fed back to the transmitter using less data (e.g., only 6 vectors are communicated (e.g., transmitted, sent, signaled) to the transmitter rather than 9 vectors).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

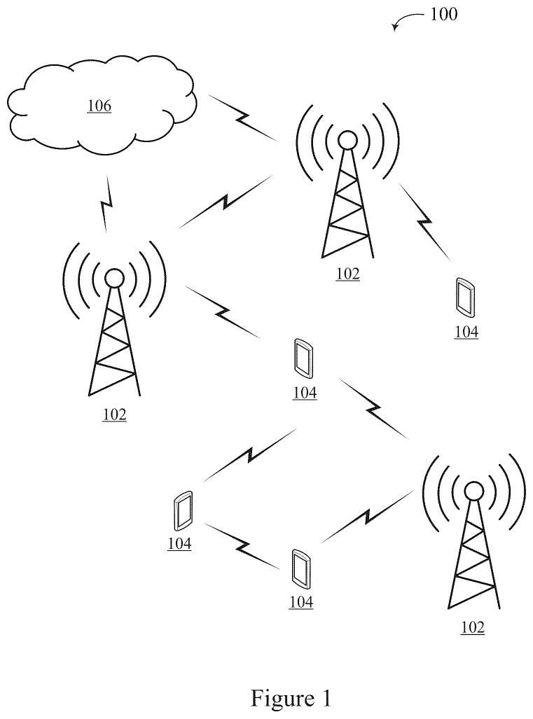

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. An NE, such as one or more of the NE 102 described herein, may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Information matrices can be communicated between the NEs 102 and the UEs 104. In one example, such information matrices include a CSI matrix, transmitted from a UE 104 to a NE 102, that characterizes the CSI for a DL channel from the NE 102 to the UE 104. In another example, such information matrices include a CSI matrix, transmitted from a NE 102 to a UE 104, that characterizes the CSI for a UL channel from the UE 104 to the NE 102. Prior to transmission of the information matrix, the information matrix is compressed (e.g., at the UE 104 for a DL channel) based at least in part on Hadamard product decomposition. The Hadamard product decomposition results in at least two factor matrices that are transmitted (e.g., to the NE 102 for a DL channel) and the receiving node (e.g., the NE 102) can reconstruct the information matrix from the at least two factor matrices.

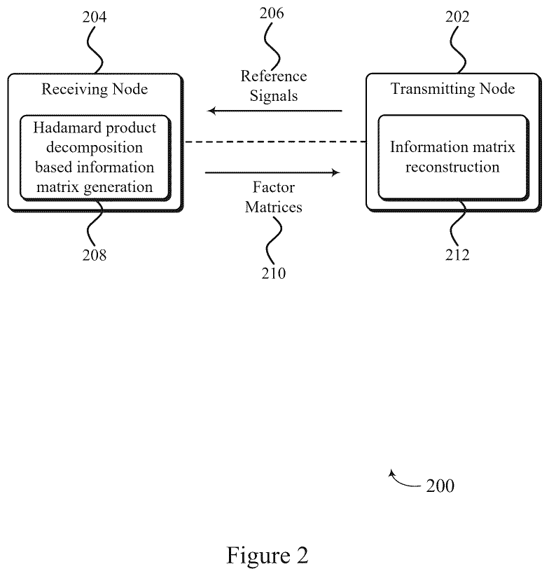

FIG. 2 illustrates an example 200 of receiving and transmitting nodes in accordance with aspects of the present disclosure. The example 200 includes a transmitting node 202 (e.g., a NE) and a receiving node 204 (e.g., a UE). The transmitting node 202 communicates (e.g., transmits, sends, signals) reference signals 206, which may also be referred to as pilot signals, to the receiving node 204. The reference signals can be, for example, one or more CSI reference signals (RSs). The receiving node 204 generates an information matrix (e.g., a CSI matrix) with parameters that characterize the CSI for the channel (e.g., a DL channel) between the transmitting node 202 and the receiving node 204.

The receiving node 204 uses Hadamard product decomposition to generate 208 two or more factor matrices 210 from the information matrix. The receiving node 204 communicates (e.g., transmits, sends, signals) the factor matrices 210 to the transmitting node 202. The transmitting node 202 communicates (e.g., receives, obtains) the factor matrices 210 and reconstructs 212 the information matrix from the factor matrices 210. The sum of the ranks of the factor matrices 210 can be less than the rank of the information matrix. Accordingly, the amount of data used to communicate the information matrix to the transmitting node 202 can be less when communicating the factor matrices 210 instead of the information matrix.

Although the discussions herein refer to a CSI matrix, it should be noted that the techniques discussed herein can be used with other types of information matrices (e.g., an information matrix that includes information other than CSI). For example, the techniques discussed herein can be used to communicate (e.g., transmit, send, signal) training data for an AI/ML model.

Communication between nodes discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of RRC, downlink control information (DCI), uplink control information (UCI), sidelink control information (SCI), medium access control element (MAC-CE), sidelink positioning protocol (SLPP), PC5 radio resource control (PC5-RRC) and so forth.

Various NR codebook types may be used for compression in the spatial and/or frequency domain. In some wireless communications systems, details are provided for NR Type-II codebook. For instance, assume that a gNB is equipped with a two-dimensional (2D) antenna array with N₁, N₂ antenna ports per polarization placed horizontally and vertically and communication occurs over N₃ Precoder Matrix Indicator (PMI) subbands. A PMI subband can consist of a set of resource blocks, each resource block consisting of a set of subcarriers. In such case, 2N₁N₂ CSI Reference Signal (CSI-RS) ports can be utilized to enable DL channel estimation with high resolution for NR Rel. 15 Type-II codebook. In order to reduce the UL feedback overhead, a Discrete Fourier transform (DFT)-based CSI compression of the spatial domain can be applied to L dimensions per polarization, where L<N₁N₂. In the sequel the indices of the 2L dimensions can be referred as the spatial domain (SD) basis indices. The magnitude and phase values of the linear combination coefficients for each subband can be fed back to the gNB as part of the CSI report. The 2N₁N₂×N₃ codebook per layer l can take on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T} ,\end{matrix}$$

$$B = [ \begin{matrix}{v}_{{l}_{0} , {m}_{0}} & {v}_{{l}_{1} , {m}_{1}} & … & {v}_{{l}_{L - 1} , {m}_{L - 1}} ] ,\end{matrix}$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. Note that O₁, O₂ oversampling factors can be assumed for the 2D DFT matrix from which matrix B is drawn. Note that W₁ can be common across all layers. W_{2,l} is a 2L×N₃ matrix, where the i^{th} column corresponds to the linear combination coefficients of the 2L beams in the i^{th} subband. Only the indices of the L selected columns of B can be reported, along with the oversampling index taking on O₁O₂ values. Note that W_{2,l} can be independent for different layers.

In some wireless communications systems, details are provided for NR Type-II port selection codebook. For instance, for Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {W}_{2 , l} .$$

Here, W₂ may follow the same structure as the conventional NR Rel. 15 Type-II Codebook, and is layer specific.

$${W}_{1}^{PS}$$

is a K×2EL block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )} ] ,\end{matrix}$$

where

$${e}_{i}^{( K )}$$

is a standard unit vector with a 1 at the i^{th} location. Here d_{PS} is an RRC parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some wireless communications systems, details are provided for NR Type-I codebook. For instance, NR Rel. 15 Type-I codebook is the baseline codebook for NR, with a variety of configurations. A common utility of Rel. 15 Type-I codebook is a special case of NR Rel. 15 Type-II codebook with L=1 for rank indicator (RI)=1, 2, where a phase coupling value is reported for each subband, e.g., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁= . . . =φ_{N}_{₃}₋₁, e.g., wideband reporting. For RI>2, different beams are used for each pair of layers. NR Rel. 15 Type-I codebook can be depicted as a low-resolution version of NR Rel. 15 Type-II codebook with spatial beam selection per layer-pair and phase combining only.

In some wireless communications systems, details are provided for NR Rel. 16 Type-I codebook. For instance, assume that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such cases, 2N₁N₂N₃ CSI-RS ports can be utilized to enable DL channel estimation with high resolution for NR Rel. 16 Type-II codebook. In order to reduce the UL feedback overhead, a DFT-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the magnitude and phase values of a subset of the delay-domain coefficients can be selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂λL matrix with columns drawn from a 2D oversampled DFT matrix, as follows:

$${u}_{m} = \begin{matrix}[ 1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${{ν}_{l , m} = \begin{matrix}[ {u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{ν}_{{l}_{0} , {m}_{0}} & {ν}_{{l}_{1} , {m}_{1}} & … & {ν}_{{l}_{L - 1} , {m}_{L - 1}}\end{matrix} ] ,$$

$${l}_{i} . = {0}_{1} {n}_{1}^{( i )} + {q}_{1} , 0 \leq {n}_{1}^{( i )} < {N}_{1} , 0 \leq {q}_{1} < {0}_{1} ,$$

$${m}_{i} . = {0}_{2} {n}_{2}^{( i )} + {q}_{2} , 0 \leq {n}_{2}^{( i )} < {N}_{2} , 0 \leq {q}_{2} < {0}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows

$${w}_{f , l} = [ \begin{matrix}{f}_{{k}_{0}} & {f}_{{k}_{1}} & … & {f}_{{k}_{M′ - 1}} ]\end{matrix} , 0 \leq {k}_{i} \leq {N}_{3} - 1 , {f}_{k} = {\begin{matrix}[ 1 & {e}^{- j \frac{2 π k}{{N}_{3}}} & … & {e}^{- j \frac{2 π k ( {N}_{3} - 1 )}{{N}_{3}}}\end{matrix}}^{T} .$$

In some scenarios the indices of the L selected columns of B are reported, along with the oversampling index taking on 0102 values. Similarly, for W_{f,l}, the indices of the M selected columns out of the predefined size-N₃ DFT matrix are reported. In the sequel the indices of the M dimensions can be referred as the selected frequency domain (FD) basis indices. Hence, L, M represent the equivalent spatial and frequency dimensions after compression, respectively. Further, the 2L×M matrix \tilde{W}₂ represents the linear combination coefficients (LCCs) of the spatial and frequency DFT-basis vectors. Both \tilde{W}₂, W_{f} can be selected independent for different layers. Amplitude and phase values of an approximately β fraction of the 2LM available coefficients are reported to the gNB (β<1) as part of the CSI report. Note that coefficients with zero amplitude values are indicated via a layer-specific bitmap matrix Sₗ of size 2L×M, where each bit of the bitmap matrix Sₗ indicates whether a coefficient has a zero-amplitude value, where for these coefficients no quantized amplitude and phase values need to be reported. Since all non-zero coefficients reported within a layer are normalized with respect to the coefficient with the largest amplitude value (strongest coefficient), where the amplitude and phase values corresponding to the strongest coefficient are set to one and zero, respectively, and hence no further amplitude and phase information is explicitly reported for this coefficient, and an indication of the index of the strongest coefficient per layer can be reported.

Hence, for a single-layer transmission, magnitude and phase values of a maximum of [2βLM]−1 coefficients (along with the indices of selected L, M DFT vectors) can be reported per layer, leading to significant reduction in CSI report size, compared with reporting 2N₁N₂×N₃−1 coefficients' information.

For NR Rel. 16 Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and W_{3,l} follow the same structure as the conventional NR Rel. 16 Type-II Codebook, where both are layer specific. The matrix

$${W}_{1}^{PS}$$

can De a K×2L block-diagonal matrix with the same structure as that in the NR Rel. 15 Type-II Port Selection Codebook.

The NR Rel. 17 Type-II Port Selection codebook can follow a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉ bits$$

are used to identify the K/2 selected ports per polarization, where this selection is common across all layers. Here, \tilde{W}_{2,l} and W_{f,l} follow the same structure as the conventional NR Rel. 16 Type-II Codebook, however M can be limited to 1,2 only, with the network configuring a window of size N={2,4} for M=2. Moreover, the bitmap is reported unless β=1 and the UE reports all the coefficients for a rank up to a value of two.

For Rel-18 potential Type-II codebook, the time-domain corresponding to slots is further compressed via DFT-based transformation, where the codebook is in the following form

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ \begin{matrix}{d}_{{q}_{0}} & {d}_{{q}_{1}} & … & {d}_{{q}_{Q - 1}} ] , 0 \leq {q}_{i} \leq {N}_{4} - 1 ,\end{matrix}$$

$${d}_{q} = [ \begin{matrix}1 & {e}^{- j \frac{2 π q}{{N}_{4}}} & … & {{e}^{- j \frac{2 π q ( {N}_{4} - 1 )}{{N}_{4}}} ]}^{T} .\end{matrix}$$

Only the indices of the Q selected columns of W_{d,l} can be reported. Note that W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with Rel-18 Type-II codebook.

In some scenarios a codebook report is partitioned into two parts based on the priority of information reported. Each part is encoded separately (Part 1 has a possibly higher code rate). A list is presented below the parameters for NR Rel. 16 Type-II codebook.

The content of a CSI report can be:

$$RI + Channel Quality Indicator ( CQI ) + Total number of coefficients \qquad Part 1$$

$$SD basis indicator + FD basis indicator / layer + Bitmap / layer + Coefficient Amplitude info / layer + Coefficient Phase info / layer + Strongest coefficient indicator / layer \qquad Part 2$$

Furthermore, Part 2 CSI can be decomposed into sub-parts each with different priority (higher priority information listed first). Such partitioning can be implemented to allow dynamic reporting size for codebook based on available resources in the UL phase. Also Type-II codebook can be based on aperiodic CSI reporting and reported in PUSCH via Downlink Control Information (DCI) triggering (with at least one exception). Type-I codebook can be based on periodic CSI reporting (physical uplink control channel (PUCCH)) or semi-persistent CSI reporting (PUSCH or PUCCH) or aperiodic reporting (PUSCH).

For priority reporting for Part 2 CSI, multiple CSI reports may be transmitted with different priorities, as shown in Table 1 below. Note that the priority of the N_{Rep} CSI reports can be based on the following:
1. A CSI report corresponding to one CSI reporting configuration for one cell may have higher priority compared with another CSI report corresponding to one other CSI reporting configuration for the same cell;
2. CSI reports intended to one cell may have higher priority compared with other CSI reports intended to another cell;
3. CSI reports may have higher priority based on the CSI report content, e.g., CSI reports carrying L1-Reference Signal Received Power (RSRP) information have higher priority;
4. CSI reports may have higher priority based on their type, e.g., whether the CSI report is aperiodic, semi-persistent or periodic, and whether the report is sent via PUSCH or PUCCH, may impact the priority of the CSI report.

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Accordingly, CSI reports may be prioritized as follows, where CSI reports with lower identifiers (IDs) have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

Where s refers to CSI reporting configuration index; Mₛ refers to maximum number of CSI reporting configurations; c refers to cell index; N_{cells} refers to number of serving cells; k is 0 for CSI reports carrying L1-RSRP or L1-Signal-to-Interference-and-Noise Ratio (SINR), or 1 otherwise; y is 0 for aperiodic reports, 1 for semi-persistent reports on PUSCH, 2 for semi-persistent reports on PUCCH, or 3 for periodic reports.

In some scenarios, for triggering aperiodic CSI reporting on PUSCH, a UE can report CSI information for the network using the CSI framework in NR Release 15. The triggering mechanism between a report setting and a resource setting can be summarized in Table 2 below.

TABLE 2
Triggering mechanism between a report
setting and a resource setting

| | | | | AP CSI |
|---|---|---|---|---|
| | | Periodic CSI | SP CSI | Report- |
| | | reporting | reporting | ing |
| Time Domain | Periodic | RRC | MAC control | DCI |
| Behavior of | CSI-RS | configured | element (CE) | |
| Resource | | | (PUCCH) | |
| Setting | | | DCI (PUSCH) | |
| | SP CSI-RS | Not Supported | MAC CE | DCI |
| | | | (PUCCH) | |
| | | | DCI (PUSCH) | |
| | AP CSI-RS | Not Supported | Not Supported | DCI |

Further, in some scenarios:
Associated Resource Settings for a CSI Report Setting have same time domain behavior.
Periodic CSI-RS/Interference Management (IM) resource and CSI reports can be assumed to be present and active once configured by RRC.
Aperiodic and semi-persistent CSI-RS/IM resources and CSI reports can be explicitly triggered or activated.
Aperiodic CSI-RS/IM resources and aperiodic CSI reports, where the triggering can be done jointly by transmitting a DCI Format 0-1.
Semi-persistent CSI-RS/IM resources and semi-persistent CSI reports can be independently activated.

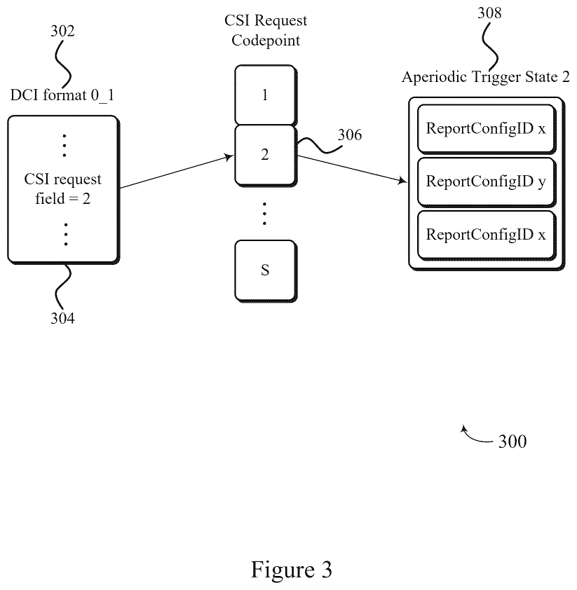

FIG. 3 illustrates an aperiodic trigger state 300 defining a list of CSI report settings. For instance, for aperiodic CSI-RS/IM resources and aperiodic CSI reports, the triggering is done jointly by transmitting a DCI Format 0_1 302. The DCI Format 0_1 302 contains a CSI request field (0 to 6 bits) 304. A non-zero request field points to a so-called aperiodic trigger state configured by RRC. For example, a CSI request field 2 points to a CSI request codepoint 306, which points to aperiodic trigger state 308. An aperiodic trigger state in turn is defined as a list of up to 16 aperiodic CSI Report Settings, identified by a CSI Report Setting identifier (ID) for which the UE calculates simultaneously CSI and transmits it on the scheduled PUSCH transmission.

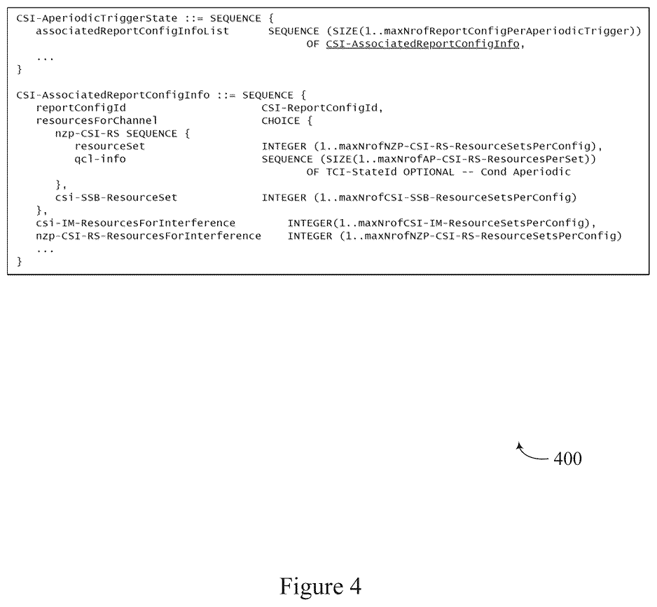

FIG. 4 illustrates an information element 400 pertaining to CSI reporting. The aperiodic trigger state indicates the resource set and quasi co-located (QCL) information. For instance, when the CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE considers that the resources used for the computation of the channel and interference can be processed with the same spatial filter e.g. quasi-co-located with respect to “QCL-TypeD.”

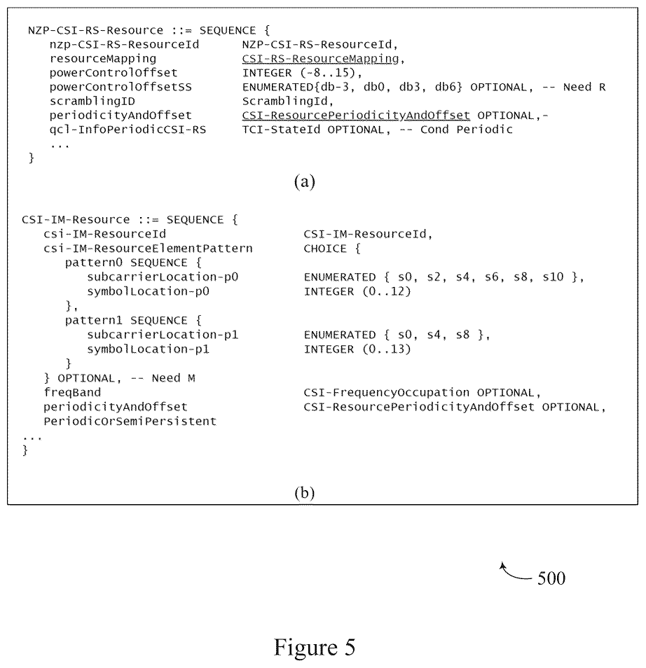

FIG. 5 illustrates an information element 500 for RRC configuration for wireless resources. The information element 500, for instance, can configure NZP-CSI-RS/CSI-IM resources. The information element 500, for instance, illustrates RRC configuration (a) for NZP-CSI-RS Resource and (b) for CSI-IM-Resource.

Table 3 summarizes the type of UL channels used for CSI reporting as a function of the CSI codebook type.

TABLE 3
Uplink channels used for CSI reporting
as a function of the CSI codebook type

| | Periodic CSI | | AP CSI |
|---|---|---|---|
| | reporting | SP CSI reporting | reporting |
| Type I wideband | PUCCH Format | PUCCH Format 2 | PUSCH |
| (WB) | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CSI-RS Resource Index (CRI) (if reported) and CQI for the first codeword,
number of non-zero wideband amplitude coefficients per layer for Type II CSI feedback on PUSCH.

CSI Part 2 has a variable payload size that can be derived from the CSI parameters in CSI Part 1 and contains PMI and the CQI for the second codeword when RI>4.

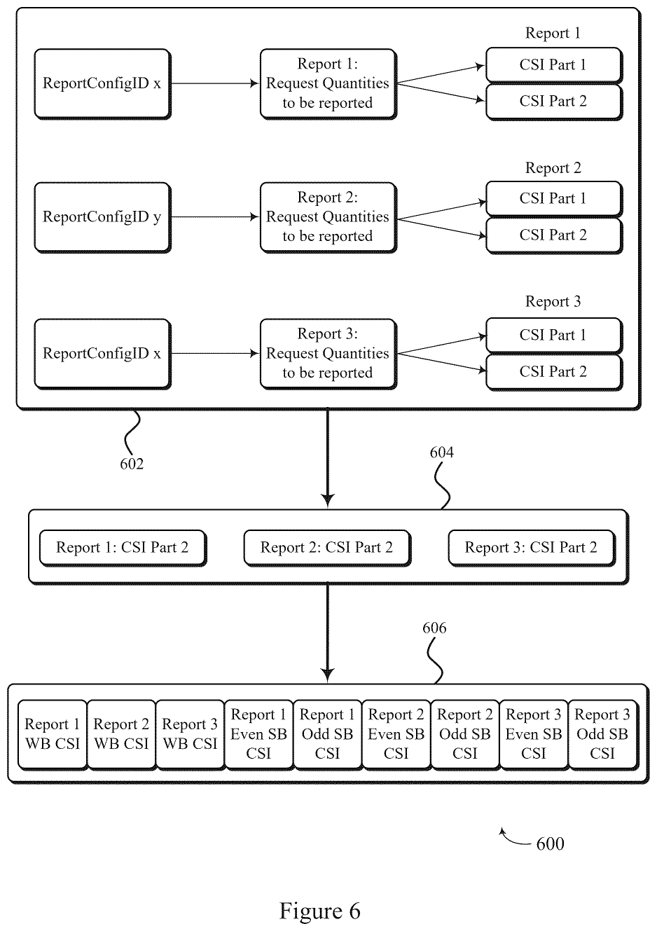

FIG. 6 illustrates a scenario 600 for partial CSI omission for PUSCH-based CSI. The scenario 600, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 602 defines 3 report settings x, y, and z, then the CSI part is reordered across CSI reports 604, resulting in the aperiodic CSI reporting for CSI part 2 ordering 606 as illustrated in the scenario 600. As illustrated in the scenario, different reports are shown in the ordering 606, including wideband (WB) CSI reports and subband (SB) CSI reports.

As mentioned above, CSI reports can be prioritized according to:
1. time-domain behavior and physical channel, where more dynamic reports are given precedence over less dynamic reports and PUSCH has precedence over PUCCH;
2. CSI content, where beam reports (e.g., L1-RSRP reporting) has priority over regular CSI reports;
3. the serving cell to which the CSI corresponds (in case of carrier aggregation (CA) operation). CSI corresponding to the PCell has priority over CSI corresponding to Scells; or
4. the reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit CQI table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, where one CQI value is reported corresponding to each physical downlink shared channel (PDSCH) transport block, and a subband format, where one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit subband differential CQI value is reported, defined as:
Sub-band Offset level(s)=subband CQI index(s)−wideband CQI index.

The mapping from the 2-bit subband differential CQI values to the offset level is shown in Table 6, as follows:

TABLE 6
Mapping subband differential CQI value to offset level

| Sub-band differential CQI | |
|---|---|
| value | Offset level |
| 0 | 0 |
| 1 | 1 |
| 2 | ≥2 |
| 3 | ≤−1 |

Low-rank approximation or compression may be performed using singular value decomposition (SVD). Consider SVD of channel matrix Hϵ [symbol] ^{r×t}, given by

$$SVD ( H ) = U \sum {V}^{*}$$

where Uϵ [symbol] ^{r×r}, Vϵ [symbol] ^{t×t} are unitary matrices made up of left and right singular vectors, respectively, of H and Σϵ [symbol] ^{r×t} is a diagonal matrix where Σᵢᵢ=σᵢ, 1≤i≤R, are the singular values of H, where σ₁≥σ₂≥ . . . ≥σ_{R} and R=min (r, t). When H is full-rank, all the singular values σᵢ, 1≤i≤R, are non-zero. When H is ill-conditioned, or not of full-rank, then some of the singular values are zero. The SVD decomposition allows matrix H to be expressed as

$$H = {\sum }_{i = 1}^{R} {σ}_{i} {U}_{: , i} {V}_{: , i}^{*}$$

Based on SVD, H can be compressed or approximated as follows.

Rank-1 approximation or compression of H: using only the first column of U and V, along with the scalar value of σ₁, Rank-1 approximation of H can be obtained. To represent rank-1 approximation of H, only r+t complex-valued matrix elements (scaled by σ₁) can be used while a full representation of H uses rt complex-valued matrix elements, enabling a lossy compression of matrix H.

Low-rank approximation or compression of H: In general, a rank R′ approximation, R′<R, of H can be obtained as

$$H = {\sum }_{i = 1}^{{R}^{′}} {σ}_{i} {U}_{: , i} {V}_{: , i}^{*}$$

Thus, by using the first R′ columns of U and V, along with σ₁, . . . , σ_{R}z_{′}, a rank R′ approximation of matrix H can be obtained. To represent rank-R′ approximation of H, R′nᵣ+R′nₜ=R′ (nᵣ+nₜ) complex-valued matrix elements are used while a full representation of H uses nᵣnₜ complex-valued matrix elements, enabling a lossy compression of matrix H.

As low-rank approximation is a lossy compression, the loss is generally computed in terms of Frobenius norm of the reconstructed matrix. The loss in rank-approximation based on SVD (as explained above), is given by ∥H-Ĥ∥_{F}, where,

$$\hat{H} = {\sum }_{i = 1}^{{R}^{′}} {σ}_{i} {U}_{: , i} {V}_{: , i}^{*}$$

With respect to artificial intelligence/machine learning (AI/ML) compression, including the paradigm of deep learning, may solve many problems in various fields. Deep neural networks (DNNs) may be explored and exploited to find more efficient solutions for the problems that arise in transmission and reception of information over wireless channels. Efficient methods (relative to the existing non-AI/ML methods) for making CSI available at the transmitter may be developed.

An autoencoder (AE) is a deep neural network that can be used for dimensionality reduction and may be used for CSI compression. An AE comprises of two parts, an encoder E_{ω}, a DNN with learnable/trainable parameters denoted by ω, and a decoder D_{ψ}, another DNN with ψ as its set of trainable/learnable parameters. The encoder learns a representation of the input signal/data (in other words, encodes the input signal/data) such that the key attributes of the input signal/data are captured as low-dimensional feature vector(s). The decoder validates the encoding and helps the encoder to refine its encoding by trying to regenerate the input signal/data from the feature vectors generated by the encoder. Thus, the encoder and the decoder are trained and developed together such that the signal/data at the input to the encoder is reconstructed, as faithfully as possible, at the output of the decoder. Thus, the two neural networks, or the two models E_{ω} and D_{ψ} together constitute an autoencoder.

An autoencoder based method for CSI compression for a wireless network can be explained as follows. For illustrative purposes, consider DL communication, from the base station to the UE. An AE is trained to efficiently encode and decode the channel matrices; e.g., the training data set comprises of a large number of wireless channel matrices (collected from the field or generated through simulations) and the AE is trained such that the encoder generates lower-dimensional latent representation of the input channel matrix and the decoder reconstructs the channel matrix from the latent representation generated by the encoder. After training, the encoder part of the AE, E_{ω}, is deployed at the UE and the decoder part of the AE, D_{ψ}, is deployed at the base station. The UE estimates the channel matrix using the reference/pilot signals received from the base station, encodes the channel matrix using the encoder E_{ω}, and transmits the encoded output (feature vectors or latent representation of channel matrix) computed by the encoder over the wireless channel towards the base station. The base station, using the decoder D_{ψ}, decodes or reconstructs the channel matrix from the feature vectors received from the UE. As the AE achieves a high amount of dimensionality reduction, it might be possible to achieve a good amount of compression of CSI information transmitted over the channel using this method. Note that the compressed CSI data at the output of the encoder is features or feature vectors computed by the encoder.

Sometimes, it would be enough for the transmitter to know the left-singular vectors of H or the eigenvectors of H*H, in place of H. The AE based CSI compression method, discussed above, can also be used for sending the singular vectors, or eigenvectors of the channel matrix. In such a case, the AE would be trained to efficiently represent or compress a matrix made up of the singular vectors or eigenvectors.

The techniques discussed herein describe decomposing an information matrix (e.g., a high-rank CSI matrix) into two or more lower-rank matrices, referred to as Hadamard factor matrices, based on Hadamard product decomposition. The Hadamard factor matrices are fed back from one node (e.g., a UE) to the other node (e.g., a NE (such as a base station)) in the wireless network. The Hadamard factor matrices can be used at the other node (e.g., the NE) to reconstruct the original CSI matrix with some loss.

The techniques discussed are based on Hadamard product decomposition, which may also be referred to as Hadamard product approximation, Hadamard product approximation of matrices, or matrix direct product decomposition. It should be noted that Hadamard product may also be referred to as “element-wise product”, “entry-wise product”, or “Schur product”. The Hadamard product is discussed below, followed by a discussion of Hadamard product decomposition.

The following notation is used herein. For a matrix Zϵ [symbol] ^{r×t}, Zᵢⱼ, Z_{i,1:t}, Z_{1:r,j} denote (i, j)^{th} element, i^{th} row, j^{th} column of matrix Z, respectively. A block of matrix Z consisting of elements in row i to i′ and column j to j′ is denoted by Z_{i:i′,j:j′}. Superscript T and superscript * denotes conjugate transpose (also known as Hermitian transpose) of a vector or a matrix. Thus, for a vector a, a″ denotes transpose of a, and a* denotes conjugate transpose (or, Hermitian) of a and the same holds true for a matrix A. Rank(A) denotes rank of matrix A. ∥A∥_{F} denotes Frobenius norm of matrix A.

With respect to Hadamard product, consider matrix A and matrix B having real-valued elements with dimensions r×t, which implies that Aϵ [symbol] ^{r×t}, Bϵ [symbol] ^{r×t} in formal mathematical notation. Hadamard product of A and B, denoted by A⊙B (e.g., the ⊙ symbol indicates Hadamard product), is defined in equation (1) as:

$$A ⊙ B = C = [ \begin{matrix}{a}_{11} {b}_{11} & … & {a}_{1 t} {b}_{1 t} \\ ⋮ & ⋱ & ⋮ \\ {a}_{r 1} {b}_{r 1} & … & {a}_{rt} {b}_{rt}\end{matrix} ] ∈ {ℝ}^{r \times t} \qquad ( 1 )$$

With respect to rank of Hadamard product, consider a real-valued matrix C of size r×t (e.g., Cϵ [symbol] ^{r×t}) is obtained through Hadamard product of two real-valued matrices A and B, each of size r×t (e.g., Aϵ [symbol] ^{r×t} and Bϵ [symbol] ^{r×t}). In such a case, if Rank(A)=R₁ and Rank(B)=R₂, then, Rank(C)≤R₁R₂. This statement may be called the rank property of Hadamard product and can be stated more formally as follows.

$$Let A ∈ {ℝ}^{r \times t} , \\ B ∈ {ℝ}^{r \times t} with Rank ( A ) = {R}_{1} and Rank ( B ) = {R}_{2} . Let C = A ⊙ B$$

Then, Rank(C)≤R₁R₂, i.e., rank of matrix Cϵ [symbol] ^{r×t} is upper bounded by R₁R₂; i.e., Rank(C)≤R₁R₂. This above upper bound on rank of C is tight and, very often, Rank(C) is equal to R₁R₂ or very close to the value R₁R₂.

An r×t matrix having a rank of R₁, can be uniquely represented by R₁(r+t) elements. Hence, matrix Aϵ [symbol] ^{r×t}, made up of a total of r×t number of real-valued elements and having a rank of R₁, can be represented by R₁(r+t) real-valued elements. By similar reasoning, matrix Bϵ [symbol] ^{r×t}, made up of a total of rt number of real-valued elements and having a rank of R₁, can be represented by R₂(r+t) real-valued elements.

As matrix C can be computed from matrices A and B through Hadamard product of A and B (as C=A⊙B), it implies that C can be represented by (R₁+R₂)(r+t) elements. Thus, if a real-valued matrix Cϵ [symbol] ^{r×t}, with Rank(C)=R₁R₂ can be expressed as Hadamard product of two matrices Aϵ [symbol] ^{r×t} and Bϵ [symbol] ^{r×t}, with Rank(A)=R₁ and Rank(A)=R₂, then we can represent the matrix C with only (R₁+R₂)(r+t) number of real-valued elements.

This approach can be compared with the required elements to represent matrix C using other methods that do not make use of the Hadamard product. As per the rank property of Hadamard matrix, Rank(C)≤R₁R₂, for simplifying the discussion, assume that Rank(C)=R₁R₂.

Consider representing matrix Cϵ [symbol] ^{r×t} and Rank(C)=R₁R₂ using conventional methods, based on SVD or basis vector methods, without using the concepts of Hadamard product. Using conventional methods (such as SVD or representing C with R₁R₂ number of basis vectors) the number of real-valued elements required to represent C is equal to R₁R₂(r+t).

It can be seen that (R₁+R₂)(r+t)<R₁R₂(r+t) for higher values of R₁R₂. Thus, representing a given matrix Cϵ [symbol] ^{r×t} through Hadamard product is more beneficial than representing the matrix C through existing conventional methods, such as SVD or eigen decomposition (ED). In other words, for a given matrix Cϵ [symbol] ^{r×t} having a higher rank, a lower number of parameters are used to represent the matrix C by making use of Hadamard product than through other conventional methods such as SVD and ED. Some examples of this benefit are discussed in more detail below, after discussing Hadamard product decomposition.

With respect to Hadamard product decomposition, through the Hadamard product and its rank property, discussed above, two lower-rank matrices can construct a higher rank matrix. In equation (1), matrices A and B maybe called Hadamard factor matrices (or, simply, factors), of matrix C.

Consider a matrix Cϵ [symbol] ^{r×t}. Single-term Hadamard product decomposition determines matrices Aϵ [symbol] ^{r×t}, Bϵ [symbol] ^{r×t} such that ∥C-A⊙B∥_{F} is reduced (e.g., minimized), and Rank(C)=Rank(A)×Rank(B). Note that ∥A∥_{F} denotes Frobenius norm of matrix A. The problem of single-term Hadamard product decomposition can be stated in equation (2) as the following constrained optimization problem:

$${min}_{A , B} {‖ C - A ⊙ B ‖}_{F} such that Rank ( C ) = Rank ( A ) \times Rank ( B ) \qquad ( 2 )$$

Here Rank(C)=Rank(A)×Rank(B) is the constraint and ∥C-A⊙B∥_{F} is the objective function. The above problem may also be referred to as the problem of finding nearest Hadamard product.

Further, it is to be noted that expressing a matrix as a Hadamard product of two or more matrices may also be referred to Hadamard product approximation, as the Hadamard product of the Hadamard factor matrices (A and B in equation (2)) may not be exactly the same as original matrix (C in equation (2)).

Currently there is no closed-form solution for solving the above optimization problem of equation (2). To solve this optimization problem and to determine Hadamard decomposition of a given matrix into two matrices, one has to depend on numerical methods, such as iterative optimization, or methods that utilize gradient descent or gradient ascent techniques or make use of deep neural networks.

In one or more implementations, a gradient descent algorithm is used for Hadamard product decomposition. A given matrix is decomposed into two lower-rank matrices, whose Hadamard product results in the given matrix (with acceptable loss in reconstruction of the original matrix), with a gradient descent algorithm determining the Hadamard decomposition.

Additionally, or alternatively, Hadamard product decomposition is performed through deep learning. Deep learning is able to solve variety of optimization problems, convex, non-convex, and in continuous domain as well as in discrete domain. Deep matrix factorization indicates that different types of matrix factorization, or, equivalently, different types of matrix decompositions, can be realized using appropriately developed deep neural networks. For a given matrix, Hadamard product decomposition can be performed using such a deep neural network.

In one or more implementations, the CSI matrix is decomposed using Hadamard product decomposition. When matrices A and B are found by solving equation (2) above, then matrix C can be represented through the lower-rank matrices A and B. In other words, matrix Cϵ [symbol] ^{r×t}, with Rank(C)=R₁R₂ can be reconstructed (with a difference between the reconstructed matrix and the original) through Hadamard product of matrices Aϵ [symbol] ^{r×t} and Bϵ [symbol] ^{r×t}, with Rank(A)=R₁ and Rank(B)=R₂. Thus, when elements of C are communicated (e.g., transmitted, sent, signaled) over a communication channel, A and B can be communicated rather than C. Hence, only (R₁+R₂)(r+t) elements/real-numbers are communicated (e.g., transmitted, sent, signaled) to represent matrix Cϵ [symbol] ^{r×t}, rather than (R₁R₂)(r+t) elements/real-numbers if other methods such as SVD or ED or any other matrix decomposition were used. Communicating (e.g., transmitting, sending, signaling) only (R₁+R₂)(r+t) elements/real numbers instead of (R₁R₂)(r+t) elements/real-numbers to represent a real-valued matrix of size r×t results in a significant savings in the communication resources and the amount of overhead.

Similar savings are found in the case when elements of a matrix C of size r×t are stored in memory. Instead of storing (R₁R₂)(r+t) real-valued elements, we only (R₁+R₂)(r+t) real-valued elements can be stored.

It should be noted that the savings in the number of parameters/real-valued elements used to represent a given matrix Cϵ [symbol] ^{r×t} implies that the matrix C is effectively being compressed. For a matrix Cϵ [symbol] ^{r×t}, a naïve or straightforward method to represent a given matrix Cϵ [symbol] ^{r×t} is through all its elements, thereby denoting all the r×t real-valued elements. Existing methods like SVD or ED in case when r=t, would use R₁R₂(r+t) number of real-valued elements/parameters to represent matrix C, where Rank(C)=R₁R₂, resulting in compressing the matrix from r×t real-valued elements/parameters to R₁R₂(r+t) number of real-valued elements/parameters. The techniques discussed herein, through Hadamard product decomposition, further compresses the matrix C to (R₁+R₂)(r+t) number of real-valued elements/parameters.

With respect to savings in parameters used to represent a matrix (or gains in compressing a matrix) through Hadamard product decomposition, by considering a few examples, the significant savings that can be had through Hadamard product decomposition of a given matrix Cϵ [symbol] ^{r×t} is illustrated. In other words, the amount of savings in the number of parameters/real-valued elements used to represent a given matrix Cϵ [symbol] ^{r×t} by decomposing it through Hadamard product decomposition into two lower-rank Hadamard factor matrices and uniquely representing the two Hadamard factor matrices, is illustrated through a few examples in the following.

Consider a matrix Cϵ [symbol] ^{r×t} having Rank(C)=8 and R₁=2, R₂=4 (or R₁=4, R₂=2). Then R₁R₂(r+t)=8(r+t) and (R₁+R₂)(r+t)=6(r+t). Thus, representing the matrix through Hadamard product decomposition results in having 25% fewer elements than using conventional methods.

Consider matrix Cϵ [symbol] ^{r×t} having Rank(C)=9 and R₁=3, R₂=3. Then R₁R₂(r+t)=9(r+t) and (R₁+R₂)(r+t)=6(r+t). Thus, representing the matrix through Hadamard product decomposition results in having about 33% fewer elements than using conventional methods.

Consider matrix CϵR [symbol] ^{r×t} having Rank(C)=10 and R₁=5, R₂=2 (or R₁=2, R₂=5). Then R₁R₂(r+t)=10(r+t) and (R₁+R₂)(r+t)=7(r+t). Thus, representing the matrix through Hadamard product decomposition results in having about 30% fewer elements than using conventional methods.

Consider matrix Cϵ [symbol] ^{r×t} having Rank(C)=12 and R₁=4, R₂=3 (or R₁=3, R₂=4). Then R₁R₂(r+t)=12(r+t) and (R₁+R₂)(r+t)=7(r+t). Thus, representing the matrix through Hadamard product decomposition results in having about 42% fewer elements than using conventional methods.

Consider matrix Cϵ [symbol] ^{r×t} having Rank(C)=14 and R₁=7, R₂=2 (or R₁=2, R₂=7). Then R₁R₂(r+t)=14(r+t) and (R₁+R₂)(r+t)=9(r+t). Thus, representing the matrix through Hadamard product decomposition results in having about 36% fewer elements than using conventional methods.

Consider matrix Cϵ [symbol] ^{r×t} having Rank(C)=15 and R₁=5, R₂=3 (or R₁=3, R₂=5). Then R₁R₂(r+t)=15(r+t) and (R₁+R₂)(r+t)=8(r+t). Thus, representing the matrix through Hadamard product decomposition results in having about 46% fewer elements than using conventional methods.

Consider matrix Cϵ [symbol] ^{r×t} having Rank(C)=16 and R₁=4, R₂=4. Then R₁R₂(r+t)=16(r+t) and (R₁+R₂)(r+t)=8(r+t). Thus, representing the matrix through Hadamard product decomposition results in having 50% fewer elements than using conventional methods.

It can be seen that, whenever R₁R₂ results in a square number, a highest savings in the number of elements to represent matrix C is obtained. For example, when Rank(C)=25, by choosing R₁=5, R₂=5, only (R₁+R₂)(r+t)=10(r+t) number of real-valued elements are used to represent matrix Cϵ [symbol] ^{r×t}, while the other methods require R₁R₂(r+t)=25(r+t) real-valued elements, resulting in a saving in the required signaling as high as 60%. By similar reasoning, it can be seen that the savings in the required signaling to represent a matrix Cϵ [symbol] ^{r×t} with Rank(C)=36, would be about 66%, with Rank(C)=49, would be about 71%, and with Rank(C)=64, would be 75%.

The above examples illustrate that the proposed techniques based on Hadamard product and Hadamard product decomposition is very beneficial for compressing real-valued higher-rank matrices.

In a wireless communication system, feedback of the factor matrices A and B from one wireless node (e.g., receiver) to the other (e.g., transmitter) may be conducted in many ways. In one or more implementations, the R₁(r+t) and R₂(r+t) real-valued elements that uniquely represent matrix A and matrix B, respectively, are quantized based on a set of pre-defined code books that are known at both the transmitter and the receiver and communicating (e.g., transmitting, sending, signaling) the resulting code book indices.

Additionally, or alternatively, the factor matrices A and B are compressed using an AI/ML model (for example, a two-sided AI/ML model like an autoencoder). The AI/ML model generates low-dimensional feature vectors from the factor matrices and the factor matrices can be communicated (e.g., transmitted, sent, signaled) by communicating (e.g., transmitting, sending, signaling) the feature vectors. At the other wireless node (e.g., the transmitter), the feature vectors are used to reconstruct the factor matrices. It should be noted that compressing matrices A and B would result in considerably lower-dimensional latent vectors compared to compressing the matrix C, as A and B have lower rank than C.

Additionally, or alternatively, one of the factor matrices may be compressed and communicated (e.g., transmitted, sent, signaled) and the other factor matrix communicated (e.g., transmitted, sent, signaled) without any further compression.

With respect to converting a complex-valued matrix into a real-valued matrix, as can be observed from the discussion above on Hadamard product decomposition, the definition of Hadamard product decomposition and algorithms for computing Hadamard product decomposition operate on a real-valued matrix. Typically, CSI matrices are complex-valued matrices, with each element having a real part and an imaginary part. For applying the Hadamard product decomposition to compress a CSI matrix (or, a channel matrix), the given complex-valued CSI matrix is mapped into a real-valued matrix and the mapping is expected to be a one-to-one mapping and reversible so that the complex-valued matrix can be recovered from its real-valued representation. Further, this mapping is expected to be known at both the transmitting node and receiving node (e.g., at the UE and at the base station/gNB).

Such a mapping can be found in any of a variety of different manners. Let Hϵ [symbol] ⁿ^{ᵣ}^{×n}^{ₜ} be the given complex-valued CSI matrix that is to be converted to a real-valued matrix. In one or more implementations, two real-valued matrices H₁ϵ [symbol] ⁿ^{ᵣ}^{×n}^{ₜ} and H₂ϵ [symbol] ⁿ^{ᵣ}^{×n}^{ₜ} are constructed, where H₁=Real(H) and H₂=Imag(H), such that H=H₁+\sqrt{−1}H₂. Here, Real(Z) denotes the real part of Z and Imag(Z) denotes imaginary part of Z. Additionally, or alternatively, H Re E [symbol] ²ⁿ^{ᵣ}^{×2n}^{ₜ}, is constructed where

$${H}_{Re} = [ \begin{matrix}Real ( H ) & - Imag ( H ) \\ Imag ( H ) & Real ( H )\end{matrix} ]$$

With respect to multi-level compression of a matrix through Hadamard product decomposition, the discussion above describes how a matrix Cϵ [symbol] ^{r×t} is compressed based on Hadamard product decomposition. Assume that matrix C of dimensions r×t and rank R₁R₂ has been decomposed into two Hadamard factor matrices A and B (such that C=A⊙B), each having dimensions r×t and with Rank(A)=R₁ and Rank(B)=R₂. This decomposition would result in a compression from R₁R₂(r+t) elements to (R₁+R₂)(r+t) elements and can be referred to as a first level of compression.

The Hadamard factor matrix A can further be decomposed through Hadamard product decomposition into two Hadamard factor matrices D and E, (such that A=DOE) with Rank(D)=q₁ and Rank(E)=q₂, where R₁=q₁q₂. By communicating (e.g., transmitting, sending, signaling) or feeding back matrices D, E and B, the matrix A can be reconstructed from the Hadamard product of D and E and then the matrix C can be reconstructed through Hadamard product of A and B. Compared to the first level of compression, this method of second level of decomposing/compressing matrix A would reduce the real-valued elements/parameters from (R₁+R₂)(r+t) to (q₁+q₂+R₂)(r+t).

In a similar manner, the Hadamard factor matrix B can further be decomposed through Hadamard product decomposition into two Hadamard factor matrices F and G, (such that B=F⊙G) with Rank(F)=p₁ and Rank(G)=p₂, where R₂=p₁p₂. By communicating (e.g., transmitting, sending, signaling) or feeding back matrices F, G and A, the matrix B can be reconstructed from the Hadamard product of F and G and then the matrix C can be reconstructed through Hadamard product of A and B. Compared to the first level of compression, this method of second level of decomposing/compressing matrix B would reduce the real-valued elements/parameters from (R₁+R₂)(r+t) to (R₁+p₁+p₂)(r+t).

When both the factor matrices A and B resulting from the first level compression are further compressed through Hadamard product decomposition using the procedure explained above, we (q₁+q₂+p₁+p₂)(r+t) real-valued elements/parameters are used to represent matrix C.

It should be noted that one or more additional levels may also be used. At each level a factor matrix can be decomposed through Hadamard product decomposition into two additional Hadamard factor matrices. For example, one or more of the factor matrices D, E, F, or G can be decomposed through Hadamard product decomposition into two additional Hadamard factor matrices.

This multi-level compression can increase the amount of compression.

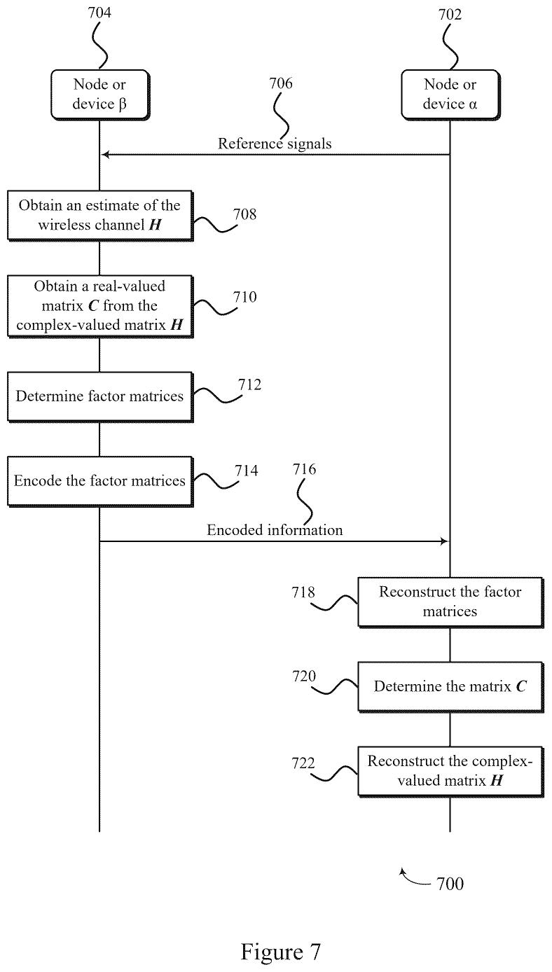

FIG. 7 illustrates an example signaling diagram 700 in accordance with aspects of the present disclosure. The signaling diagram 700 illustrates a stepwise (or, algorithmic) description of the CSI compression techniques discussed herein. Consider a wireless communication link from wireless node/device α 702 to wireless node/device β 704. Assume the wireless node/device α 702 has nₜ antennas and the node/device β 704 has with n, antennas. Thus, the wireless channel from α to β is an nᵣ×nₜ MIMO channel, denoted by Hϵ [symbol] ⁿ^{ᵣ}^{×n}^{ₜ}. The following acts summarizes the CSI feedback from node/device β 704 to node/device α 702 for enabling communication from node/device α 702 to the node/device β 704.

At 706, the node/device α 702 transmits reference signals (e.g., CSI-RS) to the node/device β 704.

At 708, the wireless node/device β 704 obtains an estimate of the wireless channel H based on the reference signals (e.g., CSI-RS) received from the node/device α 702.

At 710, the node/device β 704 obtains a real-valued matrix Cϵ [symbol] ^{r×t} from the complex-valued matrix Hϵ [symbol] ⁿ^{ᵣ}^{×n}^{ₜ}, for example,

$$C = [ \begin{matrix}Real ( H ) & - Imag ( H ) \\ Imag ( H ) & Real ( H )\end{matrix} ]$$

It should be noted that r=2nᵣ and t=2nₜ.

It should also be noted that how the node/device β 704 obtains the real-valued matrix C from the complex-valued matrix H should be known to the node/device α 702. In one example, there can be prior agreement between the nodes/devices 702 and 704 on what the mapping is between C and H, or, equivalently, the method of obtaining C from H. In another example, e.g., where there is no such prior agreement shared information regarding the mapping between C and H, the node/device β 704 communicates (e.g., transmits, sends, signals) an indication to the node/device α 702 of the mapping between C and H.

At 712, the node/device β 704 performs Hadamard product decomposition of matrix C to determine factor matrices Aϵ [symbol] ^{r×t}, Bϵ [symbol] ^{r×t} by solving the following problem:

$${min}_{A , B} {‖ C - A ⊙ B ‖}_{F} such that Rank ( C ) = Rank ( A ) \times Rank ( B )$$

At 714, information regarding the matrices A and B is encoded. The information regarding the matrices A and B can be encoded in any of a variety of different manners. In one or more implementations, the encoded information regarding the matrices A and B includes (or is only) the eigenvalues and eigenvectors of each matrix A and B, or the singular-values, left and right singular vectors of matrix A and matrix B. Additionally, or alternatively, the encoded information regarding the matrices A and B is obtained by compressing the matrices A and B (independently or jointly) by exploiting some structure or properties of the matrices (such as sparsity in the matrices, or any other structure).

Additionally, or alternatively, the encoded information regarding the matrices A and B is obtained by compressing the matrices A and B (independently or jointly) using an AI/ML model. Additionally, or alternatively, the encoded information regarding the matrices A and B is obtained by quantizing the matrices A and B (independently or jointly) using a code book, where the codebook used for matrix A can be the same as or different from the code book used for an AI/ML model.

In one or more implementations, encoding the matrices includes no further compression or quantizing the matrices using a code book. In such situations, the matrices A and B are transmitted by encoding each element of a matrix into a certain number of bits (typically, using a 32-bit representation for each element of the matrix). One or more of the matrices A or B can be encoded based on an identity operation, which does not change the matrix. E.g., a matrix may be multiplied by an identity matrix.

It should be noted that the matrices A and B can be encoded separately or jointly.

It should also be noted that how the information regarding the matrices A and B is encoded by the node/device β 704 should be known to the node/device α 702. In one example, there can be prior agreement between the nodes/devices on how to encode the matrices A and B and in another example, e.g., where there is no such prior agreement shared information regarding how the matrices A and B are encoded, the node/device β 704 communicates (e.g., transmits, sends, signals) an indication to the node/device α 702 of how the matrices A and B are encoded.

At 716, the node/device β 704 communicates (e.g., transmits, sends, signals) the encoded information regarding matrices A and B to the node/device α 702. Also at 716, the node/device α 702 communicates (e.g., receives, retrieves, obtains) the encoded information, transmitted by the node/device β 704, regarding the matrices A and B.

At 718, the node/device α 702 reconstructs matrices A and B from the encoded information received from node/device β 718. This reconstruction depends on the manner in which the information regarding the matrices A and B is encoded at the node/device β 704, which is known to the node/device α 702.

At 720, once the node/device α 702 reconstructs the matrices A and B, the node/device α 702 determines the matrix C through Hadamard product of matrices A and B

$$C = A ⊙ B$$

It should be noted that the determined matrix C is a real-valued matrix of size r×t, where r=2nᵣ and t=2nₜ.

At 722, the node/device α 702 reconstructs the complex-valued matrix H, in accordance with the mapping/method used by the node/device β 704 to obtain the real-valued matrix C from the complex-valued matrix H.

It should be noted that the techniques discussed herein can also be used to compress the covariance matrix of the CSI matrix H. The covariance matrix of H is given by either HH* or H*H, depending on whether nᵣ is higher or smaller than nₜ.

Accordingly, the techniques discussed herein intelligently make use of the properties of Hadamard product from the domain of matrix algebra and provides a new method for compressing CSI matrices, or, equivalently, MIMO channel matrices, giving considerable gains compared to existing methods when the MIMO channel matrices have a higher rank.

The techniques discussed herein can be used on their own (e.g., as a stand-alone method), or jointly with other techniques for achieving CSI compression. For example, the techniques discussed herein can be complementary to the existing methods of CSI compression, and the techniques discussed herein for compression can be used along with spatial, frequency, and/or beamspace domain compression methods, and also along with the AI/ML based CSI compression. In one or more implementations, the techniques discussed herein can improve the amount of compression when used along with other methods of compression.

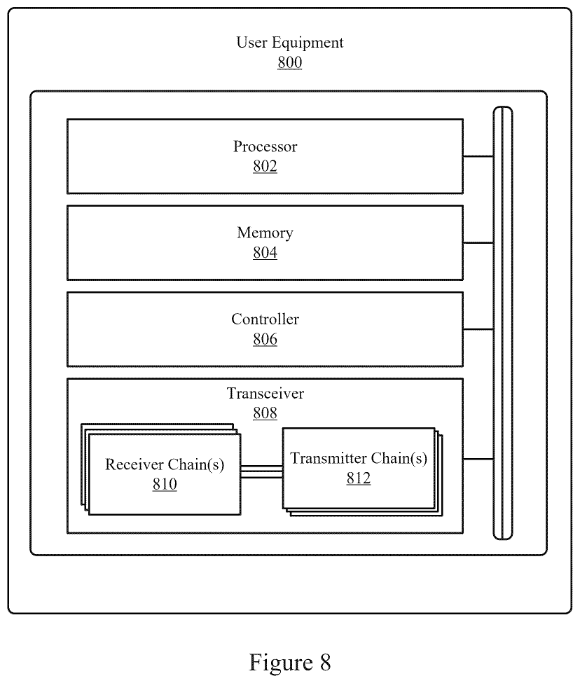

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured or operable to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured or operable to or operable to support a means for decomposing, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encoding the first factor matrix and the second factor matrix to obtain encoded information; and transmitting the encoded information.

Additionally, the UE 800 may be configured or operable to support any one or combination of where the information matrix comprises a real-valued information matrix; where the set of information parameters characterize CSI; receiving one or more reference signals from a device; and determining the CSI based at least in part on the one or more reference signals; where the CSI comprises a characterization of a channel matrix or a channel covariance matrix; mapping the set of information parameters to a real-valued information matrix of size r×t, where r≥1, where t≥1, where r is a number of rows in the real-valued information matrix, where t is a number of columns in the real-valued information matrix, and where the set of information parameters are mapped one-to-one to the real-valued information matrix; where encoding the first factor matrix and the second factor matrix further comprises determining at least one index corresponding to one or more codebooks; where encoding the first factor matrix and the second factor matrix further comprises obtaining latent representations of the first factor matrix and the second factor matrix, or compute feature vectors of the first factor matrix and the second factor matrix; encoding the first factor matrix and the second factor matrix further comprises encoding at least one of the first factor matrix and the second factor matrix based at least in part on an identity operation; determining the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix; transmitting the rank of the first factor matrix and the rank of the second factor matrix; receiving a message signal from a device to which the encoded information was transmitted, where determining the rank of the first factor matrix and the rank of the second factor matrix further comprises determining the rank of the first factor matrix and the rank of the second factor matrix based at least in part on the message signal; receiving a message signal from a first device that is different than a second device to which the encoded information was transmitted, where determining the rank of the first factor matrix and the rank of the second factor matrix further comprises determining the rank of the first factor matrix and the rank of the second factor matrix based at least in part on the message signal; transmitting, to the first device, an indication of the rank of the first factor matrix and the rank of the second factor matrix; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; decomposing, based at least in part on Hadamard product decomposition, the information matrix into the first factor matrix and the second factor matrix, further comprises: solving an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix; where the measure of the difference between the information matrix and the Hadamard product of the first factor matrix and the second factor matrix is a matrix norm of a difference matrix obtained from the difference between the information matrix and the Hadamard product of the first factor matrix and the second factor matrix; decomposing the first factor matrix and the second factor matrix further comprises decomposing, based at least in part on Hadamard product decomposition, the information matrix into the first factor matrix and the second factor matrix based at least in part on an AI/ML model; determining a mapping, where mapping the set of information parameters to the real-valued information matrix further comprises mapping the set of information parameters to the real-valued information matrix based at least in part on the determined mapping; receiving, from a device, a mapping, where mapping the set of information parameters to the real-valued information matrix further comprises mapping the set of information parameters to the real-valued information matrix based at least in part on the received mapping; transmitting, to a device, a mapping, where mapping the set of information parameters to the real-valued information matrix further comprises mapping the set of information parameters to the real-valued information matrix based at least in part on the transmitted mapping; decomposing, based at least in part on Hadamard product decomposition, the first factor matrix into a third factor matrix and a fourth factor matrix, and where encoding the first factor matrix further comprises encoding the third factor matrix and the fourth factor matrix.

Additionally, or alternatively, the UE 800 may support at least one memory (e.g., the memory 804) and at least one processor (e.g., the processor 802) coupled with the at least one memory and configured or operable to cause the UE to: decompose, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encode the first factor matrix and the second factor matrix to obtain encoded information; and transmit the encoded information.

Additionally, the UE 800 may be configured or operable to support any one or combination of where the information matrix comprises a real-valued information matrix; where the set of information parameters characterize CSI; where the at least one processor is further operable to cause the apparatus to: receive one or more reference signals from a device; and determine the CSI based at least in part on the one or more reference signals; where the CSI comprises a characterization of a channel matrix or a channel covariance matrix; where the at least one processor is further operable to cause the apparatus to map the set of information parameters to a real-valued information matrix of size r×t, where r≥1, where t≥1, where r is a number of rows in the real-valued information matrix, where t is a number of columns in the real-valued information matrix, and where the set of information parameters are mapped one-to-one to the real-valued information matrix; where to encode the first factor matrix and the second factor matrix, the at least one processor is further operable to cause the apparatus to determine at least one index corresponding to one or more codebooks; where to encode the first factor matrix and the second factor matrix, the at least one processor is further operable to cause the apparatus to obtain latent representations of the first factor matrix and the second factor matrix, or compute feature vectors of the first factor matrix and the second factor matrix; where to encode the first factor matrix and the second factor matrix, the at least one processor is further operable to cause the apparatus to encode at least one of the first factor matrix and the second factor matrix based at least in part on an identity operation; where the at least one processor is further operable to cause the apparatus to determine the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix; where the at least one processor is further operable to cause the apparatus to transmit the rank of the first factor matrix and the rank of the second factor matrix; where the at least one processor is further operable to cause the apparatus to: receive a message signal from a device to which the encoded information was transmitted, where to determine the rank of the first factor matrix and the rank of the second factor matrix, the at least one processor is further operable to cause the apparatus to determine the rank of the first factor matrix and the rank of the second factor matrix based at least in part on the message signal; where the at least one processor is further operable to cause the apparatus to: receive a message signal from a first device that is different than a second device to which the encoded information was transmitted, where to determine the rank of the first factor matrix and the rank of the second factor matrix, the at least one processor is further operable to cause the apparatus to determine the rank of the first factor matrix and the rank of the second factor matrix based at least in part on the message signal; where the at least one processor is further operable to cause the apparatus to transmit, to the first device, an indication of the rank of the first factor matrix and the rank of the second factor matrix; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to decompose, based at least in part on Hadamard product decomposition, the information matrix into the first factor matrix and the second factor matrix, the at least one processor is further operable to cause the apparatus to: solve an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix; where the measure of the difference between the information matrix and the Hadamard product of the first factor matrix and the second factor matrix is a matrix norm of a difference matrix obtained from the difference between the information matrix and the Hadamard product of the first factor matrix and the second factor matrix; where to decompose the first factor matrix and the second factor matrix, the at least one processor is further operable to cause the apparatus to decompose, based at least in part on Hadamard product decomposition, the information matrix into the first factor matrix and the second factor matrix based at least in part on an AI/ML model; where the at least one processor is further operable to cause the apparatus to: determine a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to: receive, from a device, a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to: transmit, to a device, a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to decompose, based at least in part on Hadamard product decomposition, the first factor matrix into a third factor matrix and a fourth factor matrix, and where to encode the first factor matrix, the at least one processor is further operable to cause the apparatus to encode the third factor matrix and the fourth factor matrix; where the apparatus comprises a UE; where the apparatus comprises a NE.

Additionally, or alternatively, the processor 802 may support wireless communication at the UE 800 (e.g., an apparatus) in accordance with examples as disclosed herein. The UE 800 (e.g., an apparatus) may be configured to or operable to support a means for receiving encoded information; decoding the encoded information to obtain a first factor matrix and a second factor matrix from a Hadamard product decomposition; and reconstructing an information matrix from the first factor matrix and the second factor matrix, where a product of a rank of the first factor matrix and a rank of the second factor matrix is equal to a rank of the information matrix, and where the information matrix includes a set of information parameters.

Additionally, the UE 800 (e.g., an apparatus) may be configured to or operable to support any one or combination of where the information matrix comprises a real-valued information matrix; where the set of information parameters characterize CSI; transmitting one or more reference signals to a device; where the CSI comprises a characterization of a channel matrix or a channel covariance matrix; where reconstructing the information matrix further comprises determining a Hadamard product of the first factor matrix and the second factor matrix; where information matrix comprises a real-valued information matrix of size r×t, where r=2nᵣ and t=2nₜ, where r is a number of rows in the real-valued information matrix, where t is a number of columns in the real-valued information matrix, where nᵣ is a number of antennas at a device from which the encoded information is received, and where nₜ is a number of antennas at the UE; determining a mapping; and mapping, based at least in part on the mapping, parameters of the real-valued information matrix to a complex-valued matrix; where decoding the encoded information further comprises identifying at least one index corresponding to one or more codebooks; where decoding the first factor matrix and the second factor matrix further comprises obtaining the first factor matrix and the second factor matrix from latent representations of the first factor matrix and the second factor matrix, or obtaining the first factor matrix and the second factor matrix from feature vectors of the first factor matrix and the second factor matrix; where decoding the first factor matrix and the second factor matrix further comprises decoding at least one of the first factor matrix and the second factor matrix based at least in part on an identity operation; where receiving the encoded information further comprises receiving the encoded information from a device, and the method further comprises receiving, from the device, the rank of the first factor matrix and the rank of the second factor matrix; transmitting, to a device, a message signal based at least in part on which the rank of the first factor matrix and the rank of the second factor matrix can be determined; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where receiving the encoded information further comprises receiving the encoded information from a device, and the method further comprises receiving the mapping from the device; where receiving the encoded information further comprises receiving the encoded information from a first device, and the method further comprises receiving the mapping from a second device that is different than the first device; where decoding the first factor matrix further comprises decoding a third factor matrix and a fourth factor matrix, and the method further comprises reconstructing the first factor matrix from the third factor matrix and the fourth factor matrix; where receiving the encoded information further comprises receiving the encoded information from a UE.

Additionally, or alternatively, the UE 800 (e.g., an apparatus) may support at least one memory (e.g., the memory 804) and at least one processor (e.g., the processor 802) coupled with the at least one memory and configured to or operable to cause the UE to: receive encoded information; decode the encoded information to obtain a first factor matrix and a second factor matrix from a Hadamard product decomposition; and reconstruct an information matrix from the first factor matrix and the second factor matrix, where a product of a rank of the first factor matrix and a rank of the second factor matrix is equal to a rank of the information matrix, and where the information matrix includes a set of information parameters.

Additionally, the UE 800 (e.g., an apparatus) may be configured to support any one or combination of where the information matrix comprises a real-valued information matrix; where the set of information parameters characterize CSI; where the at least one processor is further operable to cause the UE to transmit one or more reference signals to a device; where the CSI comprises a characterization of a channel matrix or a channel covariance matrix; where to reconstruct the information matrix, the at least one processor is further operable to cause the UE to determine a Hadamard product of the first factor matrix and the second factor matrix; where information matrix comprises a real-valued information matrix of size r×t, where r=2nᵣ and t=2nₜ, where r is a number of rows in the real-valued information matrix, where t is a number of columns in the real-valued information matrix, where nᵣ is a number of antennas at a device from which the encoded information is received, and where nₜ is a number of antennas at the UE; where the at least one processor is further operable to cause the UE to: determine a mapping; and map, based at least in part on the mapping, parameters of the real-valued information matrix to a complex-valued matrix; where to decode the encoded information, the at least one processor is further operable to cause the UE to identify at least one index corresponding to one or more codebooks; where to decode the first factor matrix and the second factor matrix, the at least one processor is further operable to cause the UE to obtain the first factor matrix and the second factor matrix from latent representations of the first factor matrix and the second factor matrix, or obtain the first factor matrix and the second factor matrix from feature vectors of the first factor matrix and the second factor matrix; where to decode the first factor matrix and the second factor matrix, the at least one processor is further operable to cause the UE to decode at least one of the first factor matrix and the second factor matrix based at least in part on an identity operation; where to receive the encoded information, the at least one processor is further configured or operable to cause the UE to receive the encoded information from a device, and where the at least one processor is further operable to cause the UE to receive, from the device, the rank of the first factor matrix and the rank of the second factor matrix; where the at least one processor is further operable to cause the UE to: transmit, to a device, a message signal based at least in part on which the rank of the first factor matrix and the rank of the second factor matrix can be determined; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to receive the encoded information, the at least one processor is further operable to cause the UE to receive the encoded information from a device, and where the at least one processor is further operable to cause the UE to receive the mapping from the device; where to receive the encoded information, the at least one processor is further operable to cause the UE to receive the encoded information from a first device, and where the at least one processor is further operable to cause the UE to receive the mapping from a second device that is different than the first device; where to decode the first factor matrix, the at least one processor is further operable to cause the UE to decode a third factor matrix and a fourth factor matrix, and the at least one processor is further operable to cause the UE to reconstruct the first factor matrix from the third factor matrix and the fourth factor matrix; where to receive the encoded information, the at least one processor is further operable to cause the UE to receive the encoded information from an NE.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

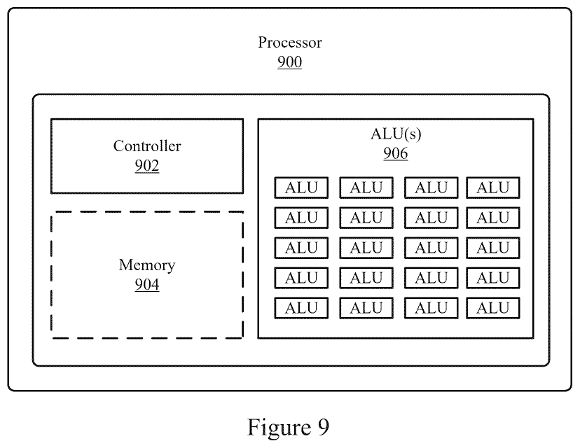

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to: decompose, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encode the first factor matrix and the second factor matrix to obtain encoded information; and transmit the encoded information.

Additionally, the processor 900 may be configured to or operable to support any one or combination of where the information matrix comprises a real-valued information matrix; where the set of information parameters characterize CSI; where the at least one controller is further operable to cause the processor to: receive one or more reference signals from a device; and determine the CSI based at least in part on the one or more reference signals; where the CSI comprises a characterization of a channel matrix or a channel covariance matrix; where the at least one controller is further operable to cause the processor to map the set of information parameters to a real-valued information matrix of size r×t, where r≥1, where t≥1, where r is a number of rows in the real-valued information matrix, where t is a number of columns in the real-valued information matrix, and where the set of information parameters are mapped one-to-one to the real-valued information matrix; where to encode the first factor matrix and the second factor matrix, the at least one controller is further operable to cause the processor to determine at least one index corresponding to one or more codebooks; where to encode the first factor matrix and the second factor matrix, the at least one controller is further operable to cause the processor to obtain latent representations of the first factor matrix and the second factor matrix, or compute feature vectors of the first factor matrix and the second factor matrix; where to encode the first factor matrix and the second factor matrix, the at least one controller is further operable to cause the processor to encode at least one of the first factor matrix and the second factor matrix based at least in part on an identity operation; where the at least one controller is further operable to cause the processor to determine the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix; where the at least one controller is further operable to cause the processor to transmit the rank of the first factor matrix and the rank of the second factor matrix; where the at least one controller is further operable to cause the processor to: receive a message signal from a device to which the encoded information was transmitted, where to determine the rank of the first factor matrix and the rank of the second factor matrix, the at least one controller is further operable to cause the processor to determine the rank of the first factor matrix and the rank of the second factor matrix based at least in part on the message signal; where the at least one controller is further operable to cause the processor to: receive a message signal from a first device that is different than a second device to which the encoded information was transmitted, where to determine the rank of the first factor matrix and the rank of the second factor matrix, the at least one controller is further operable to cause the processor to determine the rank of the first factor matrix and the rank of the second factor matrix based at least in part on the message signal; where the at least one controller is further operable to cause the processor to transmit, to the first device, an indication of the rank of the first factor matrix and the rank of the second factor matrix; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to decompose, based at least in part on Hadamard product decomposition, the information matrix into the first factor matrix and the second factor matrix, the at least one controller is further operable to cause the processor to: solve an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix; where the measure of the difference between the information matrix and the Hadamard product of the first factor matrix and the second factor matrix is a matrix norm of a difference matrix obtained from the difference between the information matrix and the Hadamard product of the first factor matrix and the second factor matrix; where to decompose the first factor matrix and the second factor matrix, the at least one controller is further operable to cause the processor to decompose, based at least in part on Hadamard product decomposition, the information matrix into the first factor matrix and the second factor matrix based at least in part on an AI/ML model; where the at least one controller is further operable to cause the processor to: determine a mapping, where to map the set of information parameters to the real-valued information matrix, the at least one controller is further operable to cause the processor to map the set of information parameters to the real-valued information matrix based at least in part on the mapping; where the at least one controller is further operable to cause the processor to: receive, from a device, a mapping, where to map the set of information parameters to the real-valued information matrix, the at least one controller is further operable to cause the processor to map the set of information parameters to the real-valued information matrix based at least in part on the mapping; where the at least one controller is further operable to cause the processor to: transmit, to a device, a mapping, where to map the set of information parameters to the real-valued information matrix, the at least one controller is further operable to cause the processor to map the set of information parameters to the real-valued information matrix based at least in part on the mapping; where the at least one controller is further operable to cause the processor to decompose, based at least in part on Hadamard product decomposition, the first factor matrix into a third factor matrix and a fourth factor matrix, and where to encode the first factor matrix, the at least one controller is further operable to cause the processor to encode the third factor matrix and the fourth factor matrix; where the processor comprises a UE; where the processor comprises a NE.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to: receive encoded information; decode the encoded information to obtain a first factor matrix and a second factor matrix from a Hadamard product decomposition; and reconstruct an information matrix from the first factor matrix and the second factor matrix, where a product of a rank of the first factor matrix and a rank of the second factor matrix is equal to a rank of the information matrix, and where the information matrix includes a set of information parameters.

Additionally, the processor 900 may be configured to or operable to support any one or combination of where the information matrix comprises a real-valued information matrix; where the set of information parameters characterize CSI; where the at least one controller is further operable to cause the processor to transmit one or more reference signals to a device; where the CSI comprises a characterization of a channel matrix or a channel covariance matrix; where to reconstruct the information matrix, the at least one controller is further operable to cause the processor to determine a Hadamard product of the first factor matrix and the second factor matrix; where information matrix comprises a real-valued information matrix of size r×t, where r=2nᵣ and t=2nₜ, where r is a number of rows in the real-valued information matrix, where t is a number of columns in the real-valued information matrix, where nᵣ is a number of antennas at a device from which the encoded information is received, and where nₜ is a number of antennas at the processor; where the at least one controller is further operable to cause the processor to: determine a mapping; and map, based at least in part on the mapping, parameters of the real-valued information matrix to a complex-valued matrix; where to decode the encoded information, the at least one controller is further operable to cause the processor to identify at least one index corresponding to one or more codebooks; where to decode the first factor matrix and the second factor matrix, the at least one controller is further operable to cause the processor to obtain the first factor matrix and the second factor matrix from latent representations of the first factor matrix and the second factor matrix, or obtain the first factor matrix and the second factor matrix from feature vectors of the first factor matrix and the second factor matrix; where to decode the first factor matrix and the second factor matrix, the at least one controller is further operable to cause the processor to decode at least one of the first factor matrix and the second factor matrix based at least in part on an identity operation; where to receive the encoded information, the at least one controller is further configured or operable to cause the processor to receive the encoded information from a device, and where the at least one controller is further operable to cause the processor to receive, from the device, the rank of the first factor matrix and the rank of the second factor matrix; where the at least one controller is further operable to cause the processor to: transmit, to a device, a message signal based at least in part on which the rank of the first factor matrix and the rank of the second factor matrix can be determined; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to receive the encoded information, the at least one controller is further operable to cause the processor to receive the encoded information from a device, and where the at least one controller is further operable to cause the processor to receive the mapping from the device; where to receive the encoded information, the at least one controller is further operable to cause the processor to receive the encoded information from a first device, and where the at least one controller is further operable to cause the processor to receive the mapping from a second device that is different than the first device; where to decode the first factor matrix, the at least one controller is further operable to cause the processor to decode a third factor matrix and a fourth factor matrix, and the at least one controller is further operable to cause the processor to reconstruct the first factor matrix from the third factor matrix and the fourth factor matrix; where to receive the encoded information, the at least one controller is further operable to cause the processor to receive the encoded information from a UE.

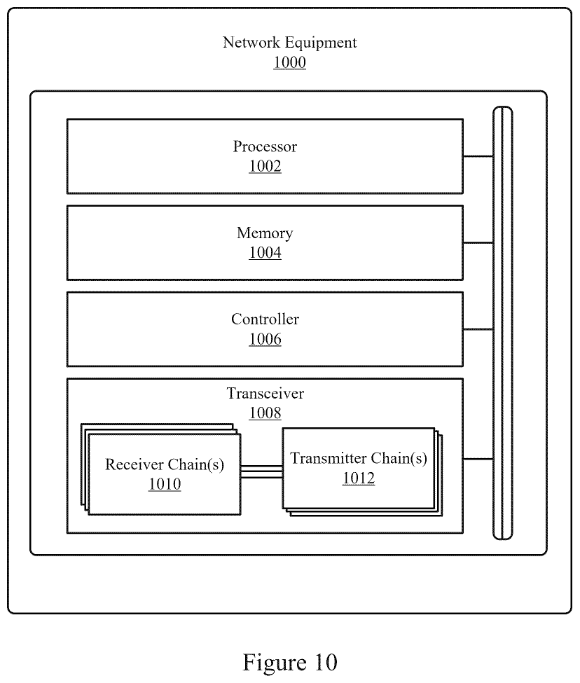

FIG. 10 illustrates an example of an NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 (e.g., an apparatus) to perform one or more of the functions described herein (e.g., executing, by the processor 1002, instructions stored in the memory 1004). For example, the processor 1002 may support wireless communication at the NE 1000 (e.g., an apparatus) in accordance with examples as disclosed herein. The NE 1000 (e.g., an apparatus) may be configured to support a means for receiving encoded information; decoding the encoded information to obtain a first factor matrix and a second factor matrix from a Hadamard product decomposition; and reconstructing an information matrix from the first factor matrix and the second factor matrix, where a product of a rank of the first factor matrix and a rank of the second factor matrix is equal to a rank of the information matrix, and where the information matrix includes a set of information parameters.

Additionally, the NE 1000 (e.g., an apparatus) may be configured to support any one or combination of where the information matrix comprises a real-valued information matrix; where the set of information parameters characterize CSI; transmitting one or more reference signals to a device; where the CSI comprises a characterization of a channel matrix or a channel covariance matrix; where reconstructing the information matrix further comprises determining a Hadamard product of the first factor matrix and the second factor matrix; where information matrix comprises a real-valued information matrix of size r×t, where r=2n, and t=2nₜ, where r is a number of rows in the real-valued information matrix, where t is a number of columns in the real-valued information matrix, where nᵣ is a number of antennas at a device from which the encoded information is received, and where nₜ is a number of antennas at the NE; determining a mapping; and mapping, based at least in part on the mapping, parameters of the real-valued information matrix to a complex-valued matrix; where decoding the encoded information further comprises identifying at least one index corresponding to one or more codebooks; where decoding the first factor matrix and the second factor matrix further comprises obtaining the first factor matrix and the second factor matrix from latent representations of the first factor matrix and the second factor matrix, or obtaining the first factor matrix and the second factor matrix from feature vectors of the first factor matrix and the second factor matrix; where decoding the first factor matrix and the second factor matrix further comprises decoding at least one of the first factor matrix and the second factor matrix based at least in part on an identity operation; where receiving the encoded information further comprises receiving the encoded information from a device, and the method further comprises receiving, from the device, the rank of the first factor matrix and the rank of the second factor matrix; transmitting, to a device, a message signal based at least in part on which the rank of the first factor matrix and the rank of the second factor matrix can be determined; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where receiving the encoded information further comprises receiving the encoded information from a device, and the method further comprises receiving the mapping from the device; where receiving the encoded information further comprises receiving the encoded information from a first device, and the method further comprises receiving the mapping from a second device that is different than the first device; where decoding the first factor matrix further comprises decoding a third factor matrix and a fourth factor matrix, and the method further comprises reconstructing the first factor matrix from the third factor matrix and the fourth factor matrix; where receiving the encoded information further comprises receiving the encoded information from a UE.

Additionally, or alternatively, the NE 1000 (e.g., an apparatus) may support at least one memory (e.g., the memory 1004) and at least one processor (e.g., the processor 1002) coupled with the at least one memory and configured to or operable to cause the NE to: receive encoded information; decode the encoded information to obtain a first factor matrix and a second factor matrix from a Hadamard product decomposition; and reconstruct an information matrix from the first factor matrix and the second factor matrix, where a product of a rank of the first factor matrix and a rank of the second factor matrix is equal to a rank of the information matrix, and where the information matrix includes a set of information parameters.

Additionally, the NE 1000 (e.g., an apparatus) may be configured to support any one or combination of where the information matrix comprises a real-valued information matrix; where the set of information parameters characterize CSI; where the at least one processor is further operable to cause the NE to transmit one or more reference signals to a device; where the CSI comprises a characterization of a channel matrix or a channel covariance matrix; where to reconstruct the information matrix, the at least one processor is further operable to cause the NE to determine a Hadamard product of the first factor matrix and the second factor matrix; where information matrix comprises a real-valued information matrix of size r×t, where r=2nᵣ and t=2nₜ, where r is a number of rows in the real-valued information matrix, where t is a number of columns in the real-valued information matrix, where nᵣ is a number of antennas at a device from which the encoded information is received, and where nₜ is a number of antennas at the NE; where the at least one processor is further operable to cause the NE to: determine a mapping; and map, based at least in part on the mapping, parameters of the real-valued information matrix to a complex-valued matrix; where to decode the encoded information, the at least one processor is further operable to cause the NE to identify at least one index corresponding to one or more codebooks; where to decode the first factor matrix and the second factor matrix, the at least one processor is further operable to cause the NE to obtain the first factor matrix and the second factor matrix from latent representations of the first factor matrix and the second factor matrix, or obtain the first factor matrix and the second factor matrix from feature vectors of the first factor matrix and the second factor matrix; where to decode the first factor matrix and the second factor matrix, the at least one processor is further operable to cause the NE to decode at least one of the first factor matrix and the second factor matrix based at least in part on an identity operation; where to receive the encoded information, the at least one processor is further configured to cause the NE to receive the encoded information from a device, and where the at least one processor is further operable to cause the NE to receive, from the device, the rank of the first factor matrix and the rank of the second factor matrix; where the at least one processor is further operable to cause the NE to: transmit, to a device, a message signal based at least in part on which the rank of the first factor matrix and the rank of the second factor matrix can be determined; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to receive the encoded information, the at least one processor is further operable to cause the NE to receive the encoded information from a device, and where the at least one processor is further operable to cause the NE to receive the mapping from the device; where to receive the encoded information, the at least one processor is further operable to cause the NE to receive the encoded information from a first device, and where the at least one processor is further operable to cause the NE to receive the mapping from a second device that is different than the first device; where to decode the first factor matrix, the at least one processor is further operable to cause the NE to decode a third factor matrix and a fourth factor matrix, and the at least one processor is further operable to cause the NE to reconstruct the first factor matrix from the third factor matrix and the fourth factor matrix; where to receive the encoded information, the at least one processor is further operable to cause the NE to receive the encoded information from a UE.

Additionally, or alternatively, the NE 1000 (e.g., an apparatus) may be configured to support a means for decomposing, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encoding the first factor matrix and the second factor matrix to obtain encoded information; and transmitting the encoded information.

Additionally, the NE 1000 (e.g., an apparatus) may be configured to support any one or combination of where the information matrix comprises a real-valued information matrix; where the set of information parameters characterize CSI; receiving one or more reference signals from a device; and determining the CSI based at least in part on the one or more reference signals; where the CSI comprises a characterization of a channel matrix or a channel covariance matrix; where r≥1, where t≥1, where r is a number of rows in the real-valued information matrix, where t is a number of columns in the real-valued information matrix, and where the set of information parameters are mapped one-to-one to the real-valued information matrix; where encoding the first factor matrix and the second factor matrix further comprises determining at least one index corresponding to one or more codebooks; where encoding the first factor matrix and the second factor matrix further comprises obtaining latent representations of the first factor matrix and the second factor matrix, or compute feature vectors of the first factor matrix and the second factor matrix; where encoding the first factor matrix and the second factor matrix further comprises encoding at least one of the first factor matrix and the second factor matrix based at least in part on an identity operation; determining the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix; transmitting the rank of the first factor matrix and the rank of the second factor matrix; receiving a message signal from a device to which the encoded information was transmitted, where determining the rank of the first factor matrix and the rank of the second factor matrix further comprises determining the rank of the first factor matrix and the rank of the second factor matrix based at least in part on the message signal; receiving a message signal from a first device that is different than a second device to which the encoded information was transmitted, where determining the rank of the first factor matrix and the rank of the second factor matrix further comprises determining the rank of the first factor matrix and the rank of the second factor matrix based at least in part on the message signal; transmitting, to the first device, an indication of the rank of the first factor matrix and the rank of the second factor matrix; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix decomposing, based at least in part on Hadamard product decomposition, the information matrix into the first factor matrix and the second factor matrix, further comprises: solving an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix; where the measure of the difference between the information matrix and the Hadamard product of the first factor matrix and the second factor matrix is a matrix norm of a difference matrix obtained from the difference between the information matrix and the Hadamard product of the first factor matrix and the second factor matrix; decomposing the first factor matrix and the second factor matrix further comprises decomposing, based at least in part on Hadamard product decomposition, the information matrix into the first factor matrix and the second factor matrix based at least in part on an AI/ML model; determining a mapping, where mapping the set of information parameters to the real-valued information matrix further comprises mapping the set of information parameters to the real-valued information matrix based at least in part on the determined mapping; receiving, from a device, a mapping, where mapping the set of information parameters to the real-valued information matrix further comprises mapping the set of information parameters to the real-valued information matrix based at least in part on the received mapping; transmitting, to a device, a mapping, where mapping the set of information parameters to the real-valued information matrix further comprises mapping the set of information parameters to the real-valued information matrix based at least in part on the transmitted mapping; decomposing, based at least in part on Hadamard product decomposition, the first factor matrix into a third factor matrix and a fourth factor matrix, and where encoding the first factor matrix further comprises encoding the third factor matrix and the fourth factor matrix; where the apparatus comprises a NE.

Additionally, or alternatively, the NE 1000 (e.g., an apparatus) may support at least one memory (e.g., the memory 1004) and at least one processor (e.g., the processor 1002) coupled with the at least one memory and configured to or operable to cause the NE to: decompose, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters; encode the first factor matrix and the second factor matrix to obtain encoded information; and transmit the encoded information.

Additionally, the NE 1000 (e.g., an apparatus) may be configured to support any one or combination of where the information matrix comprises a real-valued information matrix; where the set of information parameters characterize CSI; where the at least one processor is further operable to cause the apparatus to: receive one or more reference signals from a device; and determine the CSI based at least in part on the one or more reference signals; where the CSI comprises a characterization of a channel matrix or a channel covariance matrix; where the at least one processor is further operable to cause the apparatus to map the set of information parameters to a real-valued information matrix of size r×t, where r≥1, where t≥1, where r is a number of rows in the real-valued information matrix, where t is a number of columns in the real-valued information matrix, and where the set of information parameters are mapped one-to-one to the real-valued information matrix; where to encode the first factor matrix and the second factor matrix, the at least one processor is further operable to cause the apparatus to determine at least one index corresponding to one or more codebooks; where to encode the first factor matrix and the second factor matrix, the at least one processor is further operable to cause the apparatus to obtain latent representations of the first factor matrix and the second factor matrix, or compute feature vectors of the first factor matrix and the second factor matrix; where to encode the first factor matrix and the second factor matrix, the at least one processor is further operable to cause the apparatus to encode at least one of the first factor matrix and the second factor matrix based at least in part on an identity operation; where the at least one processor is further operable to cause the apparatus to determine the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix; where the at least one processor is further operable to cause the apparatus to transmit the rank of the first factor matrix and the rank of the second factor matrix; where the at least one processor is further operable to cause the apparatus to: receive a message signal from a device to which the encoded information was transmitted, where to determine the rank of the first factor matrix and the rank of the second factor matrix, the at least one processor is further operable to cause the apparatus to determine the rank of the first factor matrix and the rank of the second factor matrix based at least in part on the message signal; where the at least one processor is further operable to cause the apparatus to: receive a message signal from a first device that is different than a second device to which the encoded information was transmitted, where to determine the rank of the first factor matrix and the rank of the second factor matrix, the at least one processor is further operable to cause the apparatus to determine the rank of the first factor matrix and the rank of the second factor matrix based at least in part on the message signal; where the at least one processor is further operable to cause the apparatus to transmit, to the first device, an indication of the rank of the first factor matrix and the rank of the second factor matrix; where the rank of the first factor matrix is less than the rank of the information matrix and the rank of the second factor matrix is less than the rank of the information matrix; where a dimension of the first factor matrix is equal to a dimension of the information matrix and where a dimension of the second factor matrix is equal to the dimension of the information matrix; where to decompose, based at least in part on Hadamard product decomposition, the information matrix into the first factor matrix and the second factor matrix, the at least one processor is further operable to cause the apparatus to: solve an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix; where the measure of the difference between the information matrix and the Hadamard product of the first factor matrix and the second factor matrix is a matrix norm of a difference matrix obtained from the difference between the information matrix and the Hadamard product of the first factor matrix and the second factor matrix; where to decompose the first factor matrix and the second factor matrix, the at least one processor is further operable to cause the apparatus to decompose, based at least in part on Hadamard product decomposition, the information matrix into the first factor matrix and the second factor matrix based at least in part on an AI/ML model; where the at least one processor is further operable to cause the apparatus to: determine a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to: receive, from a device, a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to: transmit, to a device, a mapping, where to map the set of information parameters to the real-valued information matrix, the at least one processor is further operable to cause the apparatus to map the set of information parameters to the real-valued information matrix based at least in part on the mapping; where the at least one processor is further operable to cause the apparatus to decompose, based at least in part on Hadamard product decomposition, the first factor matrix into a third factor matrix and a fourth factor matrix, and where to encode the first factor matrix, the at least one processor is further operable to cause the apparatus to encode the third factor matrix and the fourth factor matrix; where the apparatus comprises a UE; where the apparatus comprises a NE.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

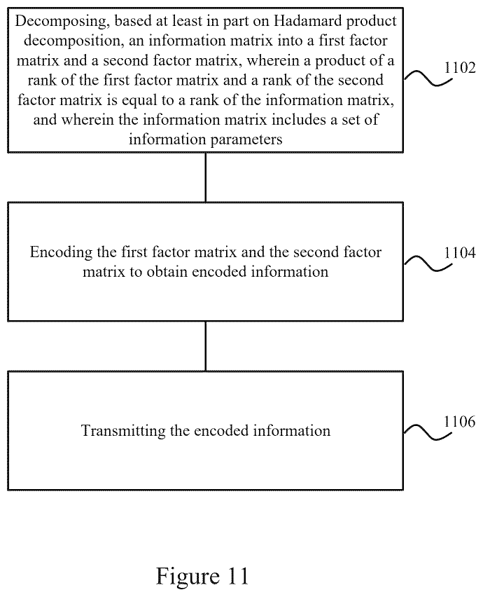

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include decomposing, based at least in part on Hadamard product decomposition, an information matrix into a first factor matrix and a second factor matrix, where a product of a rank of the first factor matrix and a rank of the second factor matrix is equal to a rank of the information matrix, and where the information matrix includes a set of information parameters. The operations of 1102 may be performed in accordance with examples as described herein. In some implementations, aspects of the operations of 1102 may be performed by a UE as described with reference to FIG. 8 or an NE as described with reference to FIG. 10.

At 1104, the method may include encoding the first factor matrix and the second factor matrix to obtain encoded information. The operations of 1104 may be performed in accordance with examples as described herein. In some implementations, aspects of the operations of 1104 may be performed by a UE as described with reference to FIG. 8 or an NE as described with reference to FIG. 10.

At 1106, the method may include transmitting the encoded information. The operations of 1106 may be performed in accordance with examples as described herein. In some implementations, aspects of the operations of 1106 may be performed a UE as described with reference to FIG. 8 or an NE as described with reference to FIG. 10.

It should be noted that the method described herein describes a possible implementation, and that the operations and the steps may be rearranged or otherwise modified and that other implementations are possible.

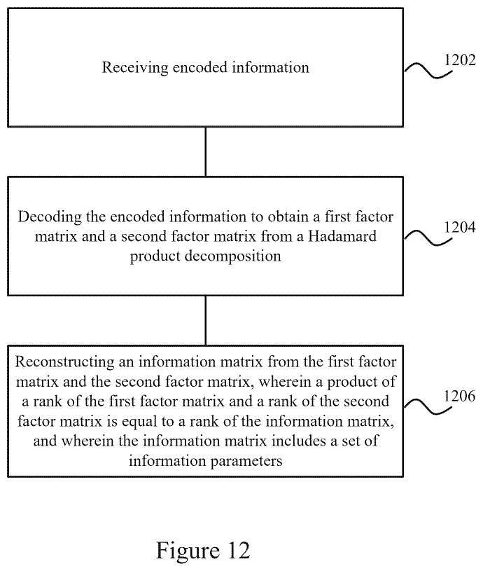

FIG. 12 illustrates a flowchart of a method in accordance with aspects of the present disclosure. The operations of the method may be implemented by an NE as described herein. In some implementations, the NE may execute a set of instructions to control the function elements of the NE to perform the described functions.

At 1202, the method may include receiving encoded information. The operations of 1202 may be performed in accordance with examples as described herein. In some implementations, aspects of the operations of 1202 may be performed by an NE as described with reference to FIG. 10 or a UE as described with reference to FIG. 8.

At 1204, the method may include decoding the encoded information to obtain a first factor matrix and a second factor matrix from a Hadamard product decomposition. The operations of 1204 may be performed in accordance with examples as described herein. In some implementations, aspects of the operations of 1204 may be performed by an NE as described with reference to FIG. 10 or a UE as described with reference to FIG. 8.

At 1206, the method may include reconstructing an information matrix from the first factor matrix and the second factor matrix, where a product of a rank of the first factor matrix and a rank of the second factor matrix is equal to a rank of the information matrix, and where the information matrix includes a set of information parameters. The operations of 1206 may be performed in accordance with examples as described herein. In some implementations, aspects of the operations of 1206 may be performed an NE as described with reference to FIG. 10 or a UE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
decompose, based at least in part on Hadamard product decomposition, an information matrix into a first factor matrix and a second factor matrix, wherein a product of a rank of the first factor matrix and a rank of the second factor matrix is equal to a rank of the information matrix, and wherein the information matrix includes a set of information parameters;
encode the first factor matrix and the second factor matrix to obtain encoded information; and
transmit the encoded information.

2. The apparatus of claim 1, wherein the information matrix comprises a real-valued information matrix.

3. The apparatus of claim 1, wherein the set of information parameters characterize channel state information (CSI).

4. The apparatus of claim 1, wherein the at least one processor is further operable to cause the apparatus to map the set of information parameters to a real-valued information matrix of size r×t, wherein r≥1, wherein t≥1, wherein r is a number of rows in the real-valued information matrix, wherein t is a number of columns in the real-valued information matrix, and wherein the set of information parameters are mapped one-to-one to the real-valued information matrix.

5. The apparatus of claim 1, wherein to encode the first factor matrix and the second factor matrix, the at least one processor is further operable to cause the apparatus to determine at least one index corresponding to one or more codebooks.

6. The apparatus of claim 1, wherein to encode the first factor matrix and the second factor matrix, the at least one processor is further operable to cause the apparatus to obtain latent representations of the first factor matrix and the second factor matrix, or compute feature vectors of the first factor matrix and the second factor matrix.

7. The apparatus of claim 1, wherein the at least one processor is further operable to cause the apparatus to determine the rank of the first factor matrix and the rank of the second factor matrix by minimizing a sum of the rank of the first factor matrix and the rank of the second factor matrix while the product of the rank of the first factor matrix and the rank of the second factor matrix is equal to the rank of the information matrix.

8. The apparatus of claim 1, wherein the rank of the first factor matrix is less than the rank of the information matrix and the rank of the second factor matrix is less than the rank of the information matrix.

9. The apparatus of claim 1, wherein a dimension of the first factor matrix is equal to a dimension of the information matrix and wherein a dimension of the second factor matrix is equal to the dimension of the information matrix.

10. The apparatus of claim 1, wherein to decompose, based at least in part on Hadamard product decomposition, the information matrix into the first factor matrix and the second factor matrix, the at least one processor is further operable to cause the apparatus to:
solve an optimization problem that minimizes a measure of a difference between the information matrix and a Hadamard product of the first factor matrix and the second factor matrix under a constraint of making the rank of the information matrix equal to a product of the rank of the first factor matrix with the rank of the second factor matrix.

11. The apparatus of claim 10, wherein the measure of the difference between the information matrix and the Hadamard product of the first factor matrix and the second factor matrix is a matrix norm of a difference matrix obtained from the difference between the information matrix and the Hadamard product of the first factor matrix and the second factor matrix.

12. The apparatus of claim 1, wherein to decompose the first factor matrix and the second factor matrix, the at least one processor is further operable to cause the apparatus to decompose, based at least in part on Hadamard product decomposition, the information matrix into the first factor matrix and the second factor matrix based at least in part on an artificial intelligence/machine learning (AI/ML) model.

13. The apparatus of claim 1, wherein the at least one processor is further operable to cause the apparatus to decompose, based at least in part on Hadamard product decomposition, the first factor matrix into a third factor matrix and a fourth factor matrix, and wherein to encode the first factor matrix, the at least one processor is further operable to cause the apparatus to encode the third factor matrix and the fourth factor matrix.

14. A network equipment (NE) for wireless communication, comprising:
at least one memory; and
at least one processor coupled with the at least one memory and operable to cause the NE to:
receive encoded information;
decode the encoded information to obtain a first factor matrix and a second factor matrix from a Hadamard product decomposition; and
reconstruct an information matrix from the first factor matrix and the second factor matrix, wherein a product of a rank of the first factor matrix and a rank of the second factor matrix is equal to a rank of the information matrix, and wherein the information matrix includes a set of information parameters.

15. The NE of claim 14, wherein the set of information parameters characterize channel state information (CSI).

16. The NE of claim 14, wherein to reconstruct the information matrix, the at least one processor is further operable to cause the NE to determine a Hadamard product of the first factor matrix and the second factor matrix.

17. The NE of claim 14, wherein information matrix comprises a real-valued information matrix of size r×t, wherein r=2nᵣ and t=2nₜ, wherein r is a number of rows in the real-valued information matrix, wherein t is a number of columns in the real-valued information matrix, wherein nᵣ is a number of antennas at a device from which the encoded information is received, and wherein nₜ is a number of antennas at the NE.

18. The NE of claim 17, wherein the at least one processor is further operable to cause the NE to:
determine a mapping; and
map, based at least in part on the mapping, parameters of the real-valued information matrix to a complex-valued matrix.

19. A method performed by an apparatus, the method comprising:
decomposing, based at least in part on Hadamard product decomposition, an information matrix into a first factor matrix and a second factor matrix, wherein a product of a rank of the first factor matrix and a rank of the second factor matrix is equal to a rank of the information matrix, and wherein the information matrix includes a set of information parameters;
encoding the first factor matrix and the second factor matrix to obtain encoded information; and
transmitting the encoded information.

20. A method performed by a network equipment (NE), the method comprising:
receiving encoded information;
decoding the encoded information to obtain a first factor matrix and a second factor matrix from a Hadamard product decomposition; and
reconstructing an information matrix from the first factor matrix and the second factor matrix, wherein a product of a rank of the first factor matrix and a rank of the second factor matrix is equal to a rank of the information matrix, and wherein the information matrix includes a set of information parameters.
